(19) United States
(12) Patent Application Publication
(10) Pub. No.: US 2026/0127774 A1
(43) Pub. Date: May 7, 2026

(54) Non-zero Vertex Normals for 3D Mesh

(71) Applicant: Ofinno, LLC, Reston, VA (US)

(72) Inventor: Chao Cao, Reston, VA (US)

(21) Appl. No.: 19/374,656

(22) Filed: Oct. 30, 2025

Related U.S. Application Data
(60) Provisional application No. 63/715,468, filed on Nov. 1, 2024.

(51) Int. Cl. G06T 9/00; G06T 17/20

(52) U.S. Cl. CPC G06T 9/001; G06T 17/20

(57) ABSTRACT

A decoder generates a subdivided mesh from a base mesh for a 3D mesh and generates vertex normals of vertices of the subdivided mesh. A vertex normal of a vertex of the vertices is generated based on: obtaining a first and second vertex, of the vertices, associated with generating the vertex, and determining, based on a first vertex normal of the first vertex and a second vertex normal of the second vertex being antiparallel vectors, a vertex normal of the vertex that is perpendicular to the first vertex normal and the second vertex normal. The decoder decodes, from a bitstream, displacement information associated with displacements of the vertices. The displacements are reconstructed by the decoder for the vertices based on the displacement information and the vertex normals.

### CROSS-REFERENCE TO RELATED APPLICATIONS

This application claims the benefit of U.S. Provisional Application No. 63/715,468, filed Nov. 1, 2024, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates an exemplary mesh coding/decoding system in which embodiments of the present disclosure may be implemented.

FIG. 2A illustrates a block diagram of an example encoder for intra encoding a 3D mesh, according to some embodiments.

FIG. 2B illustrates a block diagram of an example encoder for inter encoding a 3D mesh, according to some embodiments.

FIG. 3 illustrates a diagram showing an example decoder.

FIG. 4 is a diagram showing an example process for generating displacements of an input mesh (e.g., an input 3D mesh frame) to be encoded, according to some embodiments.

FIG. 5A illustrates an example process for approximating and encoding a geometry of a 3D mesh, according to some embodiments.

FIG. 5B illustrates an example of signaling a displacement of a vertex of a 3D mesh using a vertex normal, according to some embodiments.

FIG. 6 illustrates an example of vertices of a subdivided mesh (e.g., a subdivided base mesh) corresponding to multiple levels of detail (LODs), according to some embodiments.

FIG. 7A illustrates an example of an image packed with displacements (e.g., displacement fields or vectors) using a packing method, according to some embodiments.

FIG. 7B illustrates an example of the displacement image with labeled LODs, according to some embodiments.

FIG. 8 illustrates an example of a lifting scheme for representing displacement information of a 3D mesh as wavelet coefficients, according to some embodiments.

FIG. 9A illustrates an example of midpoint subdivision, according to some embodiments.

FIG. 9B illustrates an example of loop subdivision, according to some embodiments.

FIG. 10 shows an example diagram of normal interpolation to derive a vertex normal of a vertex from neighboring vertices of the vertex, according to some embodiments.

FIG. 11 shows an example diagram of normal interpolation with adaptive interpolation weights to derive a vertex normal of a vertex from neighboring vertices of the vertex, according to some embodiments.

FIG. 12 is a diagram showing an example of normal interpolation in which a vertex normal for vertex is determined to be zero, according to some embodiments.

FIG. 13 is a diagram showing an example of normal interpolation in which a vertex normal for vertex is determined to be non-zero, according to some embodiments.

FIG. 14 illustrates a flowchart of a method for deriving non-zero vertex normals of vertices of a subdivided mesh, according to some embodiments.

FIG. 15 illustrates a flowchart of a method for deriving non-zero vertex normals of vertices of a subdivided mesh, according to some embodiments.

FIG. 16 illustrates a flowchart of a method for encoding displacements of vertices of a 3D mesh, according to some embodiments.

FIG. 17 illustrates a flowchart of a method for decoding displacements of vertices of a 3D mesh, according to some embodiments.

FIG. 18 illustrates a block diagram of an exemplary computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of pixels that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color. Compared to traditional visual data, volumetric visual data may provide a more immersive way to experience visual data. For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is three dimensional (3D) meshes (hereinafter referred to as a mesh or a mesh frame). A mesh frame (or mesh) comprises a collection of points in three-dimensional (3D) space, also referred to as vertices. Each vertex in a mesh comprises geometry information that indicates the vertex's position in 3D space. For example, the geometry information may indicate the vertex's position in 3D space using three Cartesian coordinates (x, y, and z). Further the mesh may comprise geometry information indicating a plurality of triangles. Each triangle comprises three vertices connected by three edges and a face. One or more types of attribute information may be stored for each face (of a triangle). Attribute information may indicate a property of a face's visual appearance. For example, attribute information may indicate a texture (e.g., color) of the face, a material type of the face, transparency information of the face, reflectance information of the face, a normal vector to a surface of the face, a velocity at the face, an acceleration at the face, a time stamp indicating when the face (and/or vertex) was captured, or a modality indicating how the face (and/or vertex) was captured (e.g., running, walking, or flying). In another example, a face (or vertex) may comprise light field data in the form of multiple view-dependent texture information. Light field data may be another type of optional attribute information.

The triangles (e.g., represented by vertexes and edges) in a mesh may describe an object or a scene. For example, the triangles in a mesh may describe the external surface and/or the internal structure of an object or scene. The object or scene may be synthetically generated by a computer or may be generated from the capture of a real-world object or scene. The geometry information of a real world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Mesh data may be in the form of a mesh frame that describes an object or scene captured at a particular time instance or in the form of a sequence of mesh frames (referred to as a mesh sequence or mesh video) that describes an object or scene captured at multiple different time instances.

The data size of a mesh frame or sequence in addition with one or more types of attribute information may be too large for storage and/or transmission in many applications. For example, a single mesh frame may comprise thousands or tens or hundreds of thousands of triangles, where each triangle (e.g., vertexes and/or edges) comprises geometry information and one or more optional types of attribute information. The geometry information of each vertex may comprise three Cartesian coordinates (x, y, and z) that are each represented, for example, using 8 bits or 24 bits in total. The attribute information of each point may comprise a texture corresponding to three color components (e.g., R, G, and B color components) that are each represented, for example, using 8 bits or 24 bits in total. A single vertex therefore comprises 48 bits of information in this example, with 24 bits of geometry information and 24 bits of texture. Encoding may be used to compress the size of a mesh frame or sequence to provide for more efficient storage and/or transmission. Decoding may be used to decompress a compressed mesh frame or sequence for display and/or other forms of consumption (e.g., by a machine learning based device, neural network based device, artificial intelligence based device, or other forms of consumption by other types of machine based processing algorithms and/or devices).

Compression of meshes may be lossy (e.g., introducing differences relative to the original data) for the distribution to and visualization by an end-user, for example on AR/VR glasses or any other 3D-capable device. Lossy compression allows for a very high ratio of compression but incurs a trade-off between compression and visual quality perceived by the end-user. Other frameworks, like medical or geological applications, may require lossless compression to avoid altering the decompressed meshes.

Volumetric visual data may be stored after being encoded into a bitstream in a container, for example, a file server in the network. The end-user may request for a specific bitstream depending on the user's requirement. The user may also request for adaptive streaming of the bitstream where the trade-off between network resource consumption and visual quality perceived by the end-user is taken into consideration by an algorithm.

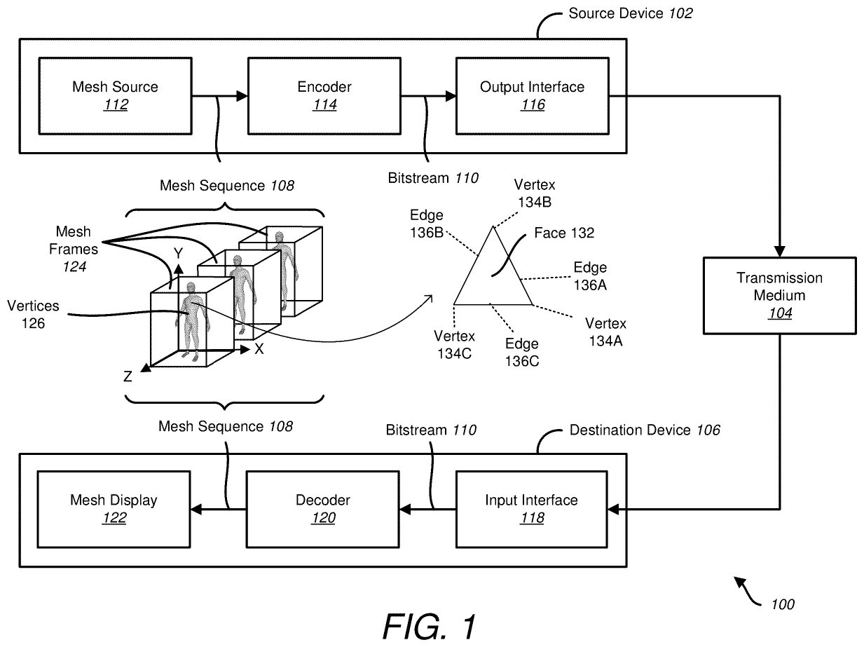

FIG. 1 illustrates an exemplary mesh coding/decoding system 100 in which embodiments of the present disclosure may be implemented. Mesh coding/decoding system 100 comprises a source device 102, a transmission medium 104, and a destination device 106. Source device 102 encodes a mesh sequence 108 into a bitstream 110 for more efficient storage and/or transmission. Source device 102 may store and/or transmit bitstream 110 to destination device 106 via transmission medium 104. Destination device 106 decodes bitstream 110 to display mesh sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode mesh sequence 108 into bitstream 110, source device 102 may comprise a mesh source 112, an encoder 114, and an output interface 116. Mesh source 112 may provide or generate mesh sequence 108 from a capture of a natural scene and/or a synthetically generated scene. A synthetically generated scene may be a scene comprising computer generated graphics. Mesh source 112 may comprise one or more mesh capture devices (e.g., one or more laser scanning devices, structured light scanning devices, modulated light scanning devices, and/or passive scanning devices), a mesh archive comprising previously captured natural scenes and/or synthetically generated scenes, a mesh feed interface to receive captured natural scenes and/or synthetically generated scenes from a mesh content provider, and/or a processor to generate synthetic mesh scenes.

As shown in FIG. 1, a mesh sequence 108 may comprise a series of mesh frames 124. A mesh frame describes an object or scene captured at a particular time instance. Mesh sequence 108 may achieve the impression of motion when a constant or variable time is used to successively present mesh frames 124 of mesh sequence 108. A (3D) mesh frame comprises a collection of vertices 126 in 3D space and geometry information of vertices 126. A 3D mesh may comprise a collection of vertices, edges, and faces that define the shape of a polyhedral object. Further, the mesh frame comprises a plurality of triangles (e.g., polygon triangles). For example, a triangle may include vertices 134A-C and edges 136A-C and a face 132. The faces usually consist of triangles (triangle mesh), Quadrilaterals (Quads), or other simple convex polygons (n-gons), since this simplifies rendering, but may also be more generally composed of concave polygons, or even polygons with holes. Each of vertices 126 may comprise geometry information that indicates the point's position in 3D space. For example, the geometry information may indicate the point's position in 3D space using three Cartesian coordinates (x, y, and z). For example, the geometry information may indicate the plurality of triangles with each comprising three vertices of vertices 126. One or more of the triangles may further comprise one or more types of attribute information. Attribute information may indicate a property of a point's visual appearance. For example, attribute information may indicate a texture (e.g., color) of a face, a material type of a face, transparency information of a face, reflectance information of a face, a normal vector to a surface of a face, a velocity at a face, an acceleration at a face, a time stamp indicating when a face was captured, a modality indicating when a face was captured (e.g., running, walking, or flying). In another example, one or more of the faces (or triangles) may comprise light field data in the form of multiple view-dependent texture information. Light field data may be another type of optional attribute information. Color attribute information of one or more of the faces may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

In some embodiments, a 3D mesh (e.g., one of mesh frames 124) may be a static or a dynamic mesh. In some examples, the 3D mesh may be represented (e.g., defined) by connectivity information, geometry information, and texture information (e.g., texture coordinates and texture connectivity). In some embodiments, the geometry information may represent locations of vertices of the 3D mesh in 3D space and the connectivity information may indicate how the vertices are to be connected together to form polygons (e.g., triangles) that make up the 3D mesh. Also, the texture coordinates indicate locations of pixels in a 2D image that correspond to vertices of a corresponding 3D mesh (or a sub-mesh of the 3D mesh). In some examples, patch information may indicate how the texture coordinates defined with respect to a 2D bounding box map into a 3D space of a 3D bounding box associated with the patch based on how the points were projected onto a projection plane for the patch. Also, the texture connectivity information may indicate how the vertices represented by the texture coordinates are to be connected together to form polygons of the 3D mesh (or sub-meshes). For example, each texture or attribute patch of the texture image may corresponds to a corresponding sub-mesh defined using texture coordinates and texture connectivity.

In some embodiments, for each 3D mesh, one or multiple 2D images may represent the textures or attributes associated with the mesh. For example, the texture information may include geometry information listed as X, Y, and Z coordinates of vertices and texture coordinates listed as 2D dimensional coordinates corresponding to the vertices. The example texture mesh may include texture connectivity information that indicates mappings between the geometry coordinates and texture coordinates to form polygons, such as triangles. For example, a first triangle may be formed by three vertices, where a first vertex is defined as the first geometry coordinate (e.g. 64.062500, 1237.739990, 51.757801), which corresponds with the first texture coordinate (e.g. 0.0897381, 0.740830). A second vertex of the triangle may be defined as the second geometry coordinate (e.g. 59.570301, 1236.819946, 54.899700), which corresponds with the second texture coordinate (e.g. 0.899059, 0.741542). Finally, a third vertex of the triangle may correspond to the third listed geometry coordinate which matches with the third listed texture coordinate. However, note that in some instances a vertex of a polygon, such as a triangle, may map to a set of geometry coordinates and texture coordinates that may have different index positions in the respective lists of geometry coordinates and texture coordinates. For example, the second triangle has a first vertex corresponding to the fourth listed set of geometry coordinates and the seventh listed set of texture coordinates. A second vertex corresponding to the first listed set of geometry coordinates and the first set of listed texture coordinates and a third vertex corresponding to the third listed set of geometry coordinates and the ninth listed set of texture coordinates.

Encoder 114 may encode mesh sequence 108 into bitstream 110. To encode mesh sequence 108, encoder 114 may apply one or more prediction techniques to reduce redundant information in mesh sequence 108. Redundant information is information that may be predicted at a decoder and therefore may not be needed to be transmitted to the decoder for accurate decoding of mesh sequence 108. For example, encoder 114 may convert attribute information (e.g., texture information) of one or more of mesh frames 124 from 3D to 2D and then apply one or more 2D video encoders or encoding methods to the 2D images. For example, any one of multiple different proprietary or standardized 2D video encoders/decoders may be used, including International Telecommunications Union Telecommunication Standardization Sector (ITU-T) H.1263, ITU-T H.1264 and Moving Picture Expert Group (MPEG)-4 Visual (also known as Advanced Video Coding (AVC)), ITU-T H.1265 and MPEG-H Part 2 (also known as High Efficiency Video Coding (HEVC), ITU-T H.1265 and MPEG-I Part 3 (also known as Versatile Video Coding (VVC)), the WebM VP8 and VP9 codecs, and AOMedia Video 1 (AV1). Encoder 114 may encode geometry of mesh sequence 108 based on video dynamic mesh coding (V-DMC). V-DMC specifies the encoded bitstream syntax and semantics for transmission or storage of a mesh sequence and the decoder operation for reconstructing the mesh sequence from the bitstream.

Output interface 116 may be configured to write and/or store bitstream 110 onto transmission medium 104 for transmission to destination device 106. In addition, or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition, or alternatively, transmission medium 104 may comprise one or more networks (e.g., the Internet) or file servers configured to store and/or transmit encoded video data.

To decode bitstream 110 into mesh sequence 108 for display or other forms of consumption, destination device 106 may comprise an input interface 118, a decoder 120, and a mesh display 122. Input interface 118 may be configured to read bitstream 110 stored on transmission medium 104 by source device 102. In addition, or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above. Decoder 120 may decode mesh sequence 108 from encoded bitstream 110. To decode attribute information (e.g., textures) of mesh sequence 108, decoder 120 may reconstruct the 2D images compressed using one or more 2D video encoders. Decoder 120 may then reconstruct the attribute information of 3D mesh frames 124 from the reconstructed 2D images. In some examples, decoder 120 may decode a mesh sequence that approximates mesh sequence 108 due to, for example, lossy compression of mesh sequence 108 by encoder 114 and/or errors introduced into encoded bitstream 110 during transmission to destination device 106. Further, decoder 120 may decode geometry of mesh sequence 108 from encoded bitstream 110, as will be further described below. Then, one or more of decoded attribute information may be applied to decoded mesh frames of mesh sequence 108.

Mesh display 122 may display mesh sequence 108 to a user. Mesh display 122 may comprise a cathode rate tube (CRT) display, a liquid crystal display (LCD), a plasma display, a light emitting diode (LED) display, a 3D display, a holographic display, a head mounted display, or any other display device suitable for displaying mesh sequence 108.

It should be noted that mesh coding/decoding system 100 is presented by way of example and not limitation. In the example of FIG. 1, mesh coding/decoding system 100 may have other components and/or arrangements. For example, mesh source 112 may be external to source device 102. Similarly, mesh display 122 may be external to destination device 106 or omitted altogether where mesh sequence is intended for consumption by a machine and/or storage device. In another example, source device 102 may further comprise a mesh decoder and destination device 106 may comprise a mesh encoder. In such an example, source device 102 may be configured to further receive an encoded bit stream from destination device 106 to support two-way mesh transmission between the devices.

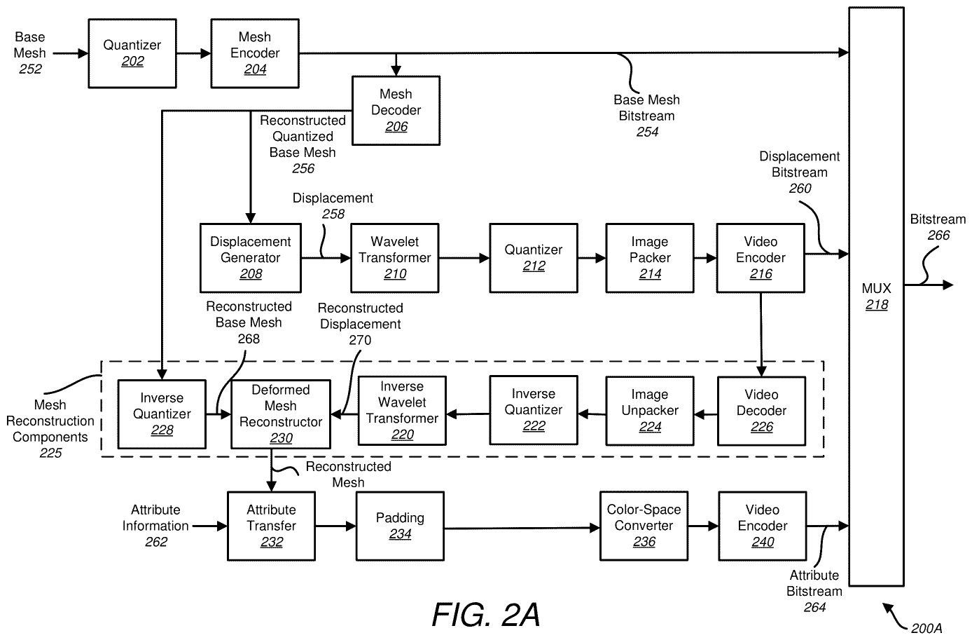

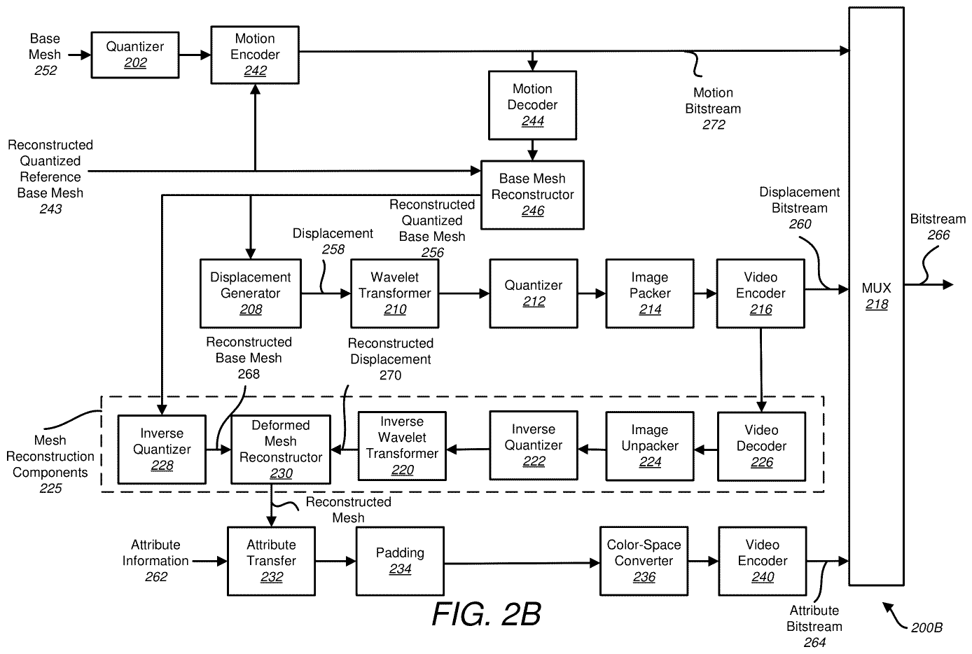

FIG. 2A illustrates a block diagram of an example encoder 200A for intra encoding a 3D mesh, according to some embodiments. For example, an encoder (e.g., encoder 114) may comprise encoder 200A.

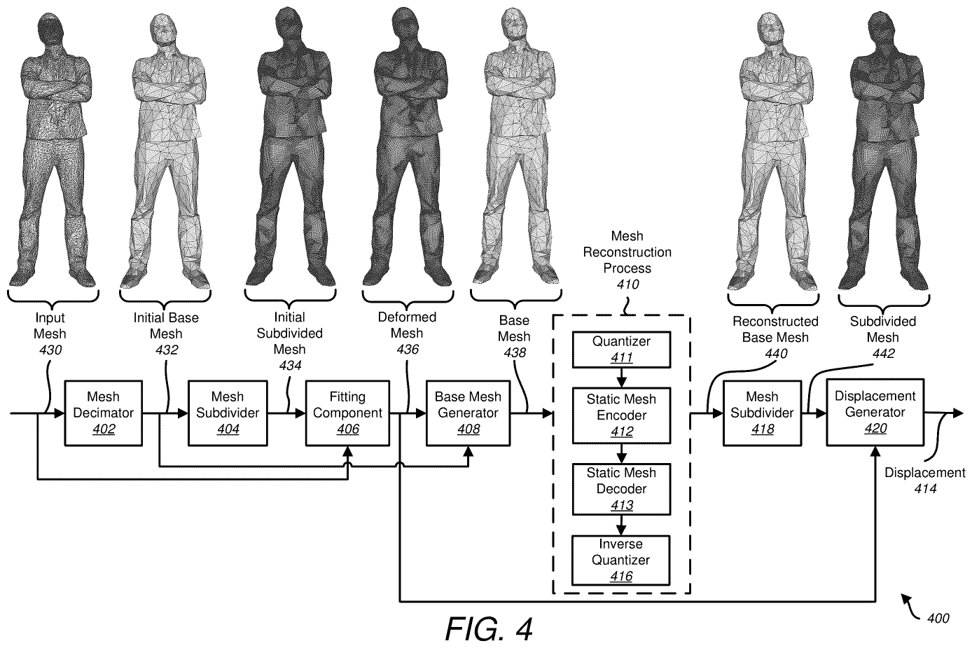

In some examples, a mesh sequence (e.g., mesh sequence 108) may include a set of mesh frames (e.g., mesh frames 124) that may be individually encoded and decoded. As will be further described below with respect to FIG. 4, a base mesh 252 may be determined (e.g., generated) from a mesh frame (e.g., an input mesh) through a decimation process. In the decimation process, the mesh topology of the mesh frame may be reduced to determine the base mesh (e.g., a decimated mesh or decimated base mesh). A mesh encoder 204 may encode base mesh 252, whose geometry information (e.g., vertices) may be quantized by quantizer 202, to generate a base mesh bitstream 254. In some examples, base mesh encoder 204 may be an existing encoder such as Draco or Edgebreaker.

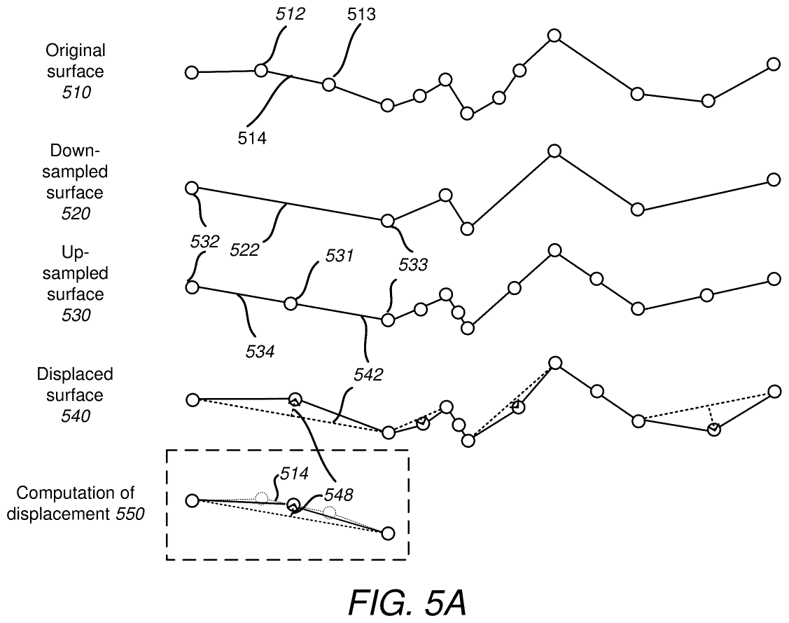

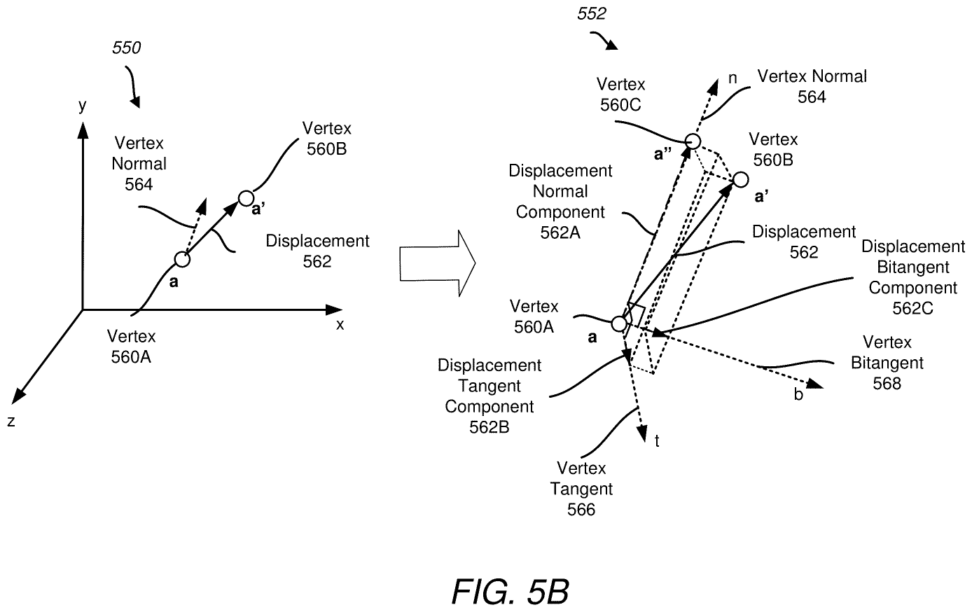

Displacement generator 208 may generate displacements for vertices of the mesh frame based on base mesh 252, as will be further explained below with respect to FIGS. 4 and 5. In some examples, the displacements are determined based on a reconstructed base mesh 256. Reconstructed base mesh 256 may be determined (e.g., output or generated) by mesh decoder 206 that decodes the encoded base mesh (e.g., in base mesh bitstream 254) determined (e.g., output or generated) by mesh encoder 204. Displacement generator 208 may subdivide reconstructed base mesh 256 using a subdivision scheme (e.g., subdivision algorithm) to determine a subdivided mesh (e.g., a subdivided base mesh). Displacement 258 may be determined based on fitting the subdivided mesh to an original input mesh surface. For example, displacement 258 for a vertex in the mesh frame may include displacement information (e.g., a displacement vector) that indicates a displacement from the position of the corresponding vertex in the subdivided mesh to the position of the vertex in the mesh frame.

Displacement 258 may be transformed by wavelet transformer 210 to generate wavelet coefficients (e.g., transformation coefficients) representing the displacement information and that may be more efficiently encoded (and subsequently decoded). The wavelet coefficients may be quantized by quantizer 212 and packed (e.g., arranged) by image packer 214 into a picture (e.g., one or more images or picture frames) to be encoded by video encoder 216. Mux 218 may combine (e.g., multiplex) the displacement bitstream 260 output by video encoder 216 together with base mesh bitstream 254 to form bitstream 266.

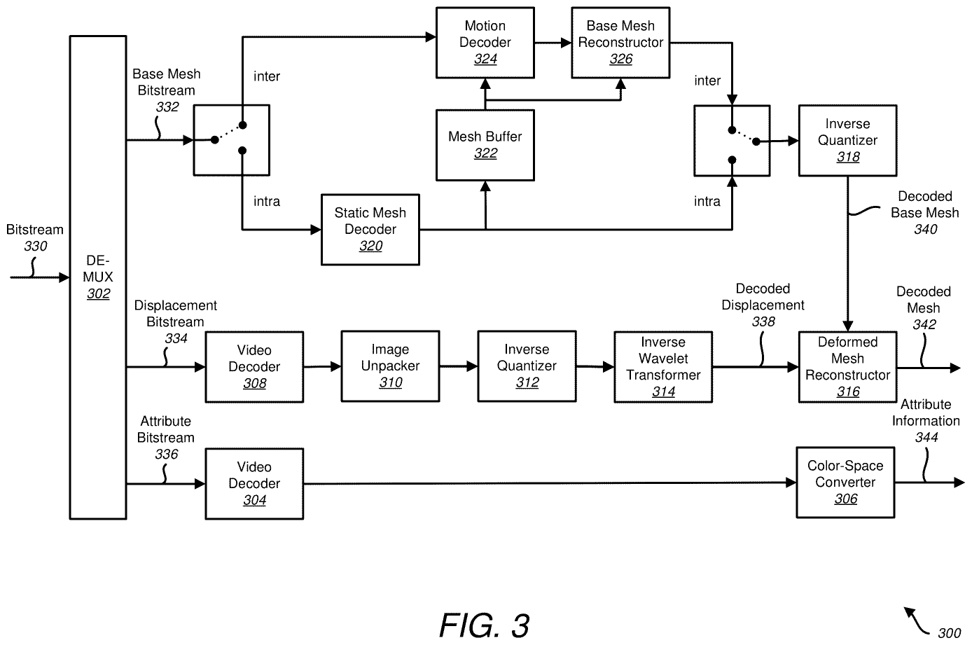

Attribute information 262 (e.g., color, texture, etc.) of the mesh frame may be encoded separately from the geometry information of the mesh frame described above. In some examples, attribute information 262 of the mesh frame may be represented (e.g., stored) by an attribute map (e.g., texture map) that associates each vertex of the mesh frame with corresponding attributes information of that vertex. Attribute transfer 232 may re-parameterize attribute information 262 in the attribute map based on reconstructed mesh determined (e.g., generated or output) from mesh reconstruction components 225. Mesh reconstruction components 225 perform inverse or decoding functions and may be the same or similar components in a decoder (e.g., decoder 300 of FIG. 3). For example, inverse quantizer 228 may inverse quantize reconstructed base mesh 256 to determine (e.g., generate or output) reconstructed base mesh 268. Video decoder 226, image unpacker 224, inverse quantizer 222, and inverse wavelet transformer 220 may perform the inverse functions as that of video encoder 216, image packer 214, quantizer 212, and wavelet transformer 210, respectively. Accordingly, reconstructed displacement 270, corresponding to displacement 258, may be generated from applying video decoder 226, image unpacker 224, inverse quantizer 222, and inverse wavelet transformer 220 in that order. Deformed mesh reconstructor 230 may determine the reconstructed mesh, corresponding to the input mesh frame, based on reconstructed base mesh 268 and reconstructed displacement 270. In some examples, the reconstructed mesh may be the same decoded mesh determined from the decoder based on decoding base mesh bitstream 254 and displacement bitstream 260.

Attribute information of the re-parameterized attribute map may be packed in images (e.g., 2D images or picture frames) by padding component 234. Padding component 234 may fill (e.g., pad) portions of the images that do not contain attribute information. In some examples, color-space converter 236 may translate (e.g., convert) the representation of color (e.g., an example of attribute information 262) from a first format to a second format (e.g., from RGB444 to YUV420) to achieve improved rate-distortion (RD) performance when encoding the attribute maps. In an example, color-space converter 236 may also perform chroma subsampling to further increase encoding performance. Finally, video encoder 240 encodes the images (e.g., pictures frames) representing attribute information 262 of the mesh frame to determine (e.g., generate or output) attribute bitstream 264 multiplexed by mux 218 into bitstream 266. In some examples, video encoder 240 may be an existing 2D video compression encoder such as an HEVC encoder or a VVC encoder.

FIG. 2B illustrates a block diagram of an example encoder 200B for inter encoding a 3D mesh, according to some embodiments. For example, an encoder (e.g., encoder 114) may comprise encoder 200B. As shown in FIG. 2B, encoder 200B comprises many of the same components as encoder 200A. In contrast to encoder 200A, encoder 200B does not include mesh encoder 204 and mesh decoder 206, which correspond to coders for static 3D meshes. Instead, encoder 200B comprises a motion encoder 242, a motion decoder 244, and a base mesh reconstructor 246. Motion encoder 242 may determine a motion field (e.g., one or more motion vectors (MVs)) that, when applied to a reconstructed quantized reference base mesh 243, best approximates base mesh 252.

The determined motion field may be encoded in bitstream 266 as motion bitstream 272. In some examples, the motion field (e.g., a motion vector in the x, y, and z directions) may be entropy coded as a codeword (e.g., for each directional component) resulting from a coding scheme such as a unary, a Golomb code (e.g., Exp-Golomb code), a Rice code, or a combination thereof. In some examples, the codeword may be arithmetically coded, e.g., using CABAC. A prefix part of the codeword may be context coded and a suffix part of the coded may be bypass coded. In some examples, a sign bit for each directional component of the motion vector may be coded separately.

In some examples, motion bitstream 272 may further include indication of the selected reconstructed quantized reference base mesh 243.

In some examples, motion bitstream 272 may be decoded by motion decoder 244 and used by base mesh reconstructor 246 to generate reconstructed quantized base mesh 256. For example, base mesh reconstructor 246 may apply the decoded motion field to reconstructed quantized reference base mesh 243 to determine (e.g., generate) reconstructed quantized base mesh 256.

In some examples, a reconstructed quantized reference base mesh m′(j) associated with a reference mesh frame with index j may be used to predict the base mesh m(i) associated with the current frame with index i. Base meshes m(i) and m(j) may comprise the same: number of vertices, connectivity, texture coordinates, and texture connectivity. The positions of vertices may differ between base meshes m(i) and m(j).

In some examples, the motion field f(i) may be computed by considering the quantized version of m(i) and the reconstructed quantized base mesh m′(j). Base mesh m′(j) may have a different number of vertices than m(j) (e.g., vertices may have been merged or removed). Therefore, the encoder may track the transformation applied to m(j) to determine (e.g., generate or obtain) m′(j) and applies it to m(i). This transformation may enable a 1-to-1 correspondence between vertices of base mesh m′(j) and the transformed and quantized version of base mesh m(i), denoted as m\hat{ }*(i). The motion field f(i) may be computed by subtracting the quantized positions Pos(i,v) of the vertex v of m\hat{ }*(i) from the positions Pos(j,v) of the vertex v of m′(j) as follows: f(i,v)=Pos(j,v)−Pos(i,v). The motion field may be further predicted by using the connectivity information of base mesh m′(j) and the prediction residuals may be entropy encoded.

In some examples, since the motion field compression process may be lossy, a reconstructed motion field denoted as f′(i) may be computed by applying the motion decoder component. A reconstructed quantized base mesh m′(i) may then be computed by adding the motion field to the positions of vertices in base mesh m′(j). To better exploit temporal correlation in the displacement and attribute map videos, inter prediction may be enabled in the video encoder.

In some embodiments, an encoder (e.g., encoder 114) may comprise encoder 200A and encoder 200B.

FIG. 3 illustrates a diagram showing an example decoder 300. Bitstream 330, which may correspond to bitstream 266 in FIGS. 2A and 2B and may be received in a binary file, may be demultiplexed by de-mux 302 to separate bitstream 330 into base mesh bitstream 332, displacement bitstream 334, and attribute bitstream 336 carrying base mesh geometry information, displacement geometry information, and attribute information, respectively. Attribute bitstream 336 may include one or more attribute map sub-streams for each attribute type.

In some examples, for inter decoding, the bitstream is de-multiplexed into separate sub-streams, including: a motion sub-stream, a displacement sub-stream for positions and potentially for each vertex attribute, zero or more attribute map sub-streams, and an atlas sub-stream containing patch information in the same manner as in V3C/V-PCC.

In some examples, base mesh bitstream 332 may be decoded in an intra mode or an inter mode. In the intra mode, static mesh decoder 320 may decode base mesh bitstream 332 (e.g., to generate reconstructed base mesh m′(i)) that is then inverse quantized by inverse quantizer 318 to determine (e.g., generate or output) decoded base mesh 340 (e.g., reconstructed quantized base mesh m″(i)). In some examples, static mesh decoder 320 may correspond to mesh decoder 206 of FIG. 2A.

In some examples, in the inter mode, base mesh bitstream 332 may include motion field information that is decoded by motion decoder 324. In some examples, motion decoder 324 may correspond to motion decoder 244 of FIG. 2B. For example, motion decoder 324 may entropy decode base mesh bitstream 332 to determine motion field information. In the inter mode, base mesh bitstream 332 may indicate a previous base mesh (e.g., reference base mesh m′(j)) decoded by static mesh decoder 320 and stored (e.g., buffered) in mesh buffer 322. Base mesh reconstructor 326 may generate a quantized reconstructed base mesh m′(i) by applying the decoded motion field (output by motion decoder 324) to the previously decoded (e.g., reconstructed) base mesh m′(j) stored in mesh buffer 322. In some examples, base mesh reconstructor 326 may correspond to base mesh reconstructor 246 of FIG. 2B. The quantized reconstructed base mesh may be inverse quantized by inverse quantizer 318 to determine (e.g., generate or output) decoded base mesh 340 (e.g., reconstructed base mesh m″(i)). In some examples, decoded base mesh 340 may be the same as reconstructed base mesh 268 in FIGS. 2A and 2B.

In some examples, decoder 300 includes video decoder 308, image unpacker 310, inverse quantizer, and inverse wavelet transformer 314 that determines (e.g., generates) decoded displacement 338 from displacement bitstream 334. Video decoder 308, image unpacker 310, inverse quantizer, and inverse wavelet transformer 314 correspond to video decoder 226, image unpacker 224, inverse quantizer 222, and inverse wavelet transformer 220, respectively, and perform the same or similar operations. For example, the picture frames (e.g., images) received in displacement bitstream 334 may be decoded by video decoder 308, the displacement information may be unpacked by image unpacker 310 from the decoded image, inverse quantized by inverse quantizer 312 to determined inverse quantized wavelet coefficients representing encoded displacement information. Then, the unquantized wavelet coefficients may be inverse transformed by inverse wavelet transformer 314 to determine decoded displacement d″(i). In other words decoded displacement 338 (e.g., decoded displacement field d″(i)) may be the same as reconstructed displacement 270 in FIGS. 2A and 2B.

Deformed mesh reconstructor 316, which corresponds to deformed mesh reconstructor 230, may determine (e.g., generate or output) decoded mesh 342 (M″(i)) based on decoded displacement 338 and decoded base mesh 340. For example, deformed mesh reconstructor 316 may combine (e.g., add) decoded displacement 338 to a subdivided decoded mesh 340 to determine decoded mesh 342.

In some examples, decoder 300 includes video decoder 304 that decodes attribute bitstream 336 comprising encoded attribute information represented (e.g., stored) in 2D images (or picture frames) to determined attribute information 344 (e.g., decoded attribute information or reconstructed attribute information). In some examples, video decoder 304 may be an existing 2D video compression decoder such as an HEVC decoder or a VVC decoder. Decoder 300 may include a color-space converter 306, which may revert the color format transformation performed by color-space converter 236 in FIGS. 2A and 2B.

FIG. 4 is a diagram 400 showing an example process (e.g., a pre-processing operations) for generating displacements 414 of an input mesh 430 (e.g., an input 3D mesh frame) to be encoded, according to some embodiments. In some examples, displacements 414 may correspond to displacement 258 shown in FIG. 2A and FIG. 2B.

In diagram 400, a mesh decimator 402 determines (e.g., generates or outputs) an initial base mesh 432 based on (e.g., using) input mesh 430. In some examples, the initial base mesh 432 may be determined (e.g., generated) from the input mesh 432 through a decimation process. In the decimation process, the mesh topology of the mesh frame may be reduced to determine the initial base mesh (which may be referred to as a decimated mesh or decimated base mesh). As will be illustrated in FIG. 5A, the decimation process may involve a down sampling process to remove vertices from the input mesh 432 so that a small portion (e.g., 6% or less) of the vertices in the input mesh 430 may remain in the initial base mesh 432.

Mesh subdivider 404 applies a subdivision scheme to generate initial subdivided mesh 434. As will be discussed in more detail with regard to FIG. 5A, the subdivision scheme may involve upsampling the initial base mesh 432 to add more vertices to the 3D mesh based on the topology and shape of the original mesh to generate the initial subdivided mesh 434.

Fitting component 406 may fit the initial subdivided mesh to determine a deformed mesh 436 that may more closely approximate the surface of input mesh 430. As will be discussed in more detail with respect to FIG. 5A, the fitting may be performed by moving vertices of the initial subdivided mesh 434 towards the surfaces of the input mesh 430 so that the subdivided mesh 434 can be used to approximate the input mesh 430. In some implementations, the fitting is performed by moving each vertex of the initial subdivided mesh 434 along the normal direction of the vertex until the vertex intersects with a surface of the input mesh 430. The resulting mesh is the deformed mesh 436. The normal direction may be indicated by a vertex normal at the vertex, which may be obtained from face normals of triangles formed by the vertex.

Base mesh generator 408 may perform another fitting process to generate a base mesh 438 from the initial base mesh 432. For example, the base mesh generator 408 may deform the initial base mesh 432 according to the deformed mesh 436 so that the initial base mesh 432 is close to the deformed mesh 436. In some implementations, the fitting process may be performed in a similar manner to the fitting component 406. For example, the base mesh generator 408 may move each of the vertices in the initial base mesh 432 along its normal direction (e.g., based on the vertex normal at each vertex) until the vertex reaches a surface of the deformed mesh 436. The output of this process is the base mesh 438.

Base mesh 438 may be output to a mesh reconstruction process 410 to generate a reconstructed base mesh 440. Reconstructed base mesh 440 may be subdivided by mesh subdivider 418 and the subdivided mesh 442 may be input to displacement generator 420 to generate (e.g., determine or output) displacement 414, as further described below with respect to FIG. 5A. In some examples, mesh subdivider 418 may apply the same subdivision scheme as that applied by mesh subdivider 404. In these examples, vertices in the subdivided mesh 442 have a one-to-one correspondence with the vertices in the deformed mesh 436. As such, the displacement generator 420 may generate the displacements 414 by calculating the difference between each vertex of the subdivided mesh 442 and the corresponding vertex of the deformed mesh 436. In some implementations, the difference may be projected onto a normal direction of the associated vertex and the resulting vector is the displacement 414. In this way, only the sign and magnitude of the displacement 414 need to be encoded in the bitstream, thereby increasing the coding efficiency. In addition, because the base mesh 438 has been fitted toward the deformed mesh 436, the displacements 414 between the deformed mesh 436 and the subdivided mesh 442 (generated from the reconstructed base mesh 440) will have small magnitudes, which further reduces the payload and increases the coding efficiency.

In some examples, one advantage of applying the subdivision process is to allow for more efficient compression, while offering a faithful approximation of the original input mesh 430 (e.g., surface or curve of the original input mesh 430). The compression efficiency may be obtained because the base mesh (e.g., decimated mesh) has a lower number of vertices compared to the number of vertices of input mesh 430 and thus requires a fewer number of bits to be encoded and transmitted. Additionally, the subdivided mesh may be automatically generated by the decoder once the base mesh has been decoded without any information needed from the encoder other than a subdivision scheme (e.g., subdivision algorithm) and parameters for the subdivision (e.g., a subdivision iteration count). The reconstructed mesh may be determined by decoding displacement information (e.g., displacement vectors) associated with vertices of the subdivided mesh (e.g., subdivided curves/surfaces of the base mesh). Not only does the subdivision process allow for spatial/quality scalability, but also the displacements may be efficiently coded using wavelet transforms (e.g., wavelet decomposition), which further increases compression performance.

In some embodiments, mesh reconstruction process 410 includes components for encoding and then decoding base mesh 438. FIG. 4 shows an example for the intra mode, in which mesh reconstruction process 410 may include quantizer 411, static mesh encoder 412, static mesh decoder 413, and inverse quantizer 416, which may perform the same or similar operations as quantizer 202, mesh encoder 204, mesh decoder 206, and inverse quantizer 228, respectively, from FIG. 2A. In the inter mode, mesh reconstruction process 410 may include quantizer 202, motion encoder 242, motion decoder 244, base mesh reconstructor 246, and inverse quantizer 228.

FIG. 5A illustrates an example process for approximating and encoding a geometry of a 3D mesh, according to some embodiments. For illustrative purposes, the 3D mesh is shown as 2D curves. An original surface 510 of the 3D mesh (e.g., a mesh frame) includes vertices (e.g., points) and edges that connect neighboring vertices. For example, point 512 and point 513 are connected by an edge corresponding to surface 514.

In some examples, a decimation process (e.g., a down-sampling process or a decimation/down-sampling scheme) may be applied to an original surface 510 of the original mesh to generate a down-sampled surface 520 of a decimated (or down-sampled) mesh. In the context of mesh compression, decimation refers to the process of reducing the number of vertices in a mesh while preserving its overall shape and topology. For example, original mesh surface 510 is decimated into a surface 520 with fewer samples (e.g., vertices and edges) but still retains the main features and shape of the original mesh surface 510. This down-sampled surface 520 may correspond to a surface of the base mesh (e.g., a decimated mesh).

In some examples, after the decimation process, a subdivision process (e.g., subdivision scheme or subdivision algorithm) may be applied to down-sampled surface 520 to generate an up-sampled surface 530 with more samples (e.g., vertices and edges). Up-sampled surface 530 may be part of the subdivided mesh (e.g., subdivided base mesh) resulting from subdividing down-sampled surface 520 corresponding to a base mesh.

Subdivision is a process that is commonly used after decimation in mesh compression to improve the visual quality of the compressed mesh. The subdivision process involves adding new vertices and faces to the mesh based on the topology and shape of the original mesh. In some examples, the subdivision process starts by taking the reduced mesh that was generated by the decimation process and iteratively adding new vertices and edges. For example, the subdivision process may comprise dividing each edge (or face) of the reduced/decimated mesh into shorter edges (or smaller faces) and creating new vertices at the points of division. These new vertices are then connected to form new faces (e.g., triangles, quadrilaterals, or another polygon). By applying subdivision after the decimation process, a higher level of compression can be achieved without significant loss of visual fidelity. Various subdivision schemes may be used such as, e.g., mid-point, Catmull-Clark subdivision, Butterfly subdivision, Loop subdivision, etc., or a combination thereof.

For example, FIG. 5A illustrates an example of the mid-point subdivision scheme that may be performed at the encoder and the decoder. In this scheme, each subdivision iteration subdivides each triangle into four sub-triangles. New vertices are introduced in the middle of each edge. The subdivision process may be applied independently to the geometry and to the texture coordinates since the connectivity for the geometry and for the texture coordinates are usually different. The subdivision scheme computes the position Pos(v₁₂) of a newly introduced vertex v₁₂ at the center or middle of an edge (v₁, v₂) formed by a first vertex (v₁) and a second vertex (v₂), as follows:

$$Pos ( {v}_{12} ) = \frac{1}{2} ( Pos ( {v}_{1} ) + Pos ( {v}_{2} ) ) , \qquad ( Eq . 1 )$$

where Pos(v₁) and Pos(v₂) are the positions of the vertices v₁ and v₂. In some examples, the same process may be used to compute the texture coordinates of the newly created vertex. For normal vectors, a normalization step may be applied as follows:

$$N ( {v}_{12} ) = \frac{N ( {v}_{1} ) + N ( {v}_{2} )}{‖ N ( {v}_{1} ) + N ( {v}_{2} ) ‖} , \qquad ( Eq . 2 )$$

N(v₁₂), N(v₁), and N(v₂) are the normal vectors associated with the vertices v₁₂, v₁, and v₂, respectively. ∥x∥ is the norm2 of the vector x.

Using the mid-point subdivision scheme, as shown in up-sampled surface 530, point 531 may be generated as the mid-point of edge 522 which is an edge connecting point 532 and point 533. Point 531 may be added as a new vertex. Edge 534 and edge 542 are also added to connect the added new vertex corresponding to point 531. In some examples, the original edge 522 may be replaced by two new edges 534 and 542.

In some examples, down-sampled surface 520 may be iteratively subdivided to generate up-sampled surface 530. For example, a first subdivided mesh resulting from a first iteration of subdivision applied to down-sampled surface 520 may be further subdivided according to the subdivision scheme to generate a second subdivided mesh, etc. In some examples, a number of iterations corresponding to levels of subdivision may be predetermined. In other examples, an encoder may indicate the number of iterations to a decoder, which may similarly generate a subdivided mesh, as further described above.

In some embodiments, the subdivided mesh may be deformed towards (e.g., approximates) the original mesh to determine (e.g., get or obtain) a prediction of the original mesh having original surface 510. The points on the subdivided mesh may be moved along a computed normal orientation until it reaches an original surface 510 of the original mesh. The distance between the intersected point on the original surface 510 and the subdivided point may be computed as a displacement (e.g., a displacement vector). For example, point 531 may be moved towards the original surface 510 along a computed normal orientation of surface (e.g., represented by edge 542). When point 531 intersects with surface 514 of the original surface 510 (of original/input mesh), a displacement vector 548 can be computed. Displacement vector 548 applied to point 531 may result in displaced surface 540, which may better approximate original surface 510. In some examples, displacement information (e.g., displacement vector 548) for vertices of the subdivided mesh (e.g., up-sampled surface 530 of subdivided mesh) may be encoded and transmitted in displacement bitstream 260 shown in examples encoders of FIGS. 2A and 2B. Note, as explained with respect to FIG. 4, the subdivided mesh corresponding to up-sampled surface may be subdivided mesh 442 that is compared to deformed mesh 436 representative of original surface 510 of the input mesh.

In some embodiments, displacements d (i) (e.g., a displacement field or displacement vectors) may be computed and/or stored based on local coordinates or global coordinates. For example, a global coordinate system is a system of reference that is used to define the position and orientation of objects or points in a 3D space. It provides a fixed frame of reference that is independent of the objects or points being described. The origin of the global coordinate system may be defined as the point where the three axes intersect. Any point in 3D space can be located by specifying its position relative to the origin along the three axes using Cartesian coordinates (x, y, z). For example, the displacements may be defined in the same cartesian coordinate system as the input or original mesh. Accordingly, a displacement may comprise three components (in the x, y, and z directions).

In a local coordinate system, a normal, a tangent, and/or a bitangent vector (which are mutually perpendicular) may be determined that defines a local basis for the 3D space to represent the orientation and position of an object in space relative to a reference frame. In some examples, displacement field d (i) may be transformed from the canonical coordinate system to the local coordinate system, e.g., defined by a normal to the subdivided mesh at each vertex (e.g., commonly referred to as a vertex normal). For example, the displacement may be represented as a displacement vector with three components (e.g., normal component, tangent component, and bitangent component) along the normal, tangent, and bitangent vectors of the local coordinate system. The vertex normal may be a unit vertex normal (e.g., a normalized vertex normal). The displacement vertex indicates a displacement from a position of a vertex to a position of a reconstructed vertex. In some examples, the normal at each vertex may be obtained from combining the face normals of triangles formed by the vertex (e.g., triangles that have the vertex in common).

In some examples, using the local coordinate system may enable further compression of tangential components of the displacements compared to the normal component. For example, a displacement vector representing a displacement may be signaled as a scalar value (e.g., including a sign and a magnitude) which may be used to derive a displacement vector based on (e.g., along) the vertex normal. For example, the displacement vector may be determined as a product of the scalar value and the vertex normal (e.g., unit normal vector) at the vertex. In some examples, because the direction of the vertex normal is generally close to that of a true displacement vector derived by the encoder, the true displacement vector may be approximated as a position along the vertex normal. In other words, the displacement vector may be signaled by the normal component with the tangent and bitangent components being zero (e.g., not signaled or signaled as zeroes). Accordingly, using local coordinate system, displacements need not be signaled as three components corresponding to the directions of the canonical coordinate system.

In some embodiments, a decoder (e.g., decoder 300 of FIG. 3) may receive and decode a base mesh corresponding to (e.g., having) down-sampled surface 520. Similar to the encoder, the decoder may apply a subdivision scheme to determine a subdivided mesh having up-sampled surface 530 generated from down-sampled surface 520. The decoder may receive and decode displacement information including displacement vector 548 and determine a decoded mesh (e.g., reconstructed mesh) based on the subdivided mesh (corresponding to up-sampled surface 530) and the decoded displacement information. For example, the decoder may add the displacement at each vertex with a position of the corresponding vertex in the subdivided mesh. The decoder may obtain a reconstructed 3D mesh by combining the obtained/decoded displacements with positions of vertices of the subdivided mesh.

FIG. 5B illustrates an example of signaling a displacement 562 of a vertex 560A (a) of a 3D mesh using a vertex normal 564, according to some embodiments. In FIG. 5B, displacement 562 may be a displacement vector indicating a displacement from vertex 560 (a) to vertex 560B (a′) representing a position of a reconstructed vertex. For example, the encoder may determine position of vertex 560B and displacement 562 according to the process described above in FIG. 5A.

In some examples, instead of signaling displacement 562 in a canonical coordinate system 550, displacement 562 may be signaled in a local coordinate system 552 defined by vertex normal 564, vertex tangent 566, and vertex bitangent 568 (i.e., vertex binormal). Vertex normal 564, vertex tangent 566, and vertex bitangent 568 are mutually perpendicular vectors and may be identically determined by the encoder and the decoder. In some examples, vertex tangent 566 and vertex bitangent 568 may be obtained from vertex normal 564. In some examples, each of vertex normal 564 (n), vertex tangent 566 (t), and vertex bitangent 568 (b) may be represented by a respective unit vector.

In some examples, displacement 562 may be represented by three components 562A-C (i.e., displacement normal component 562A, displacement tangent component 562B, displacement bitangent component 562C) along the vertex normal 564, vertex tangent 566, and vertex bitangent 568 of the local coordinate system, respectively. For example, each of the three components 562A-C may be represented by a scalar value that includes a sign and a magnitude.

In some examples, the encoder may determine and signal three components 562A-C of a displacement in a bitstream. The decoder may decode and obtain the three components (e.g., d[0], d[1], and d[2]), then reconstruct displacement 562 by multiplying the scalar values of the three components with corresponding unit vectors of vertex normal 564 (n), vertex tangent 566 (t), and vertex bitangent 568 (b), respectively. For example, vertex 560B (a′) may be obtained as follows:

$${a}^{′} = d [ 0 ] * n + d [ 1 ] * t + d [ 2 ] * b . \qquad ( Eq . 3 )$$

In some examples, further compression may be obtained by approximating displacement 562 by signaling only displacement normal component 562A along vertex normal 564. In other words, displacement tangent component 562B and displacement bitangent component 562C are omitted (or signaled as zeroes) from the bitstream. In these examples, the decoder may reconstruct vertex 560C (a″) from vertex 560A (a′). For example, the decoder may decode and obtain a scalar value of displacement normal component 562A and derive displacement normal component 562A by a product of the scalar value with vertex normal 564. The use of vertex 560C (a″) as an approximation of vertex 560B (a′) may be used to reduce bits needed to signal non-zero values for displacement tangent component 562B and displacement tangent component 562C.

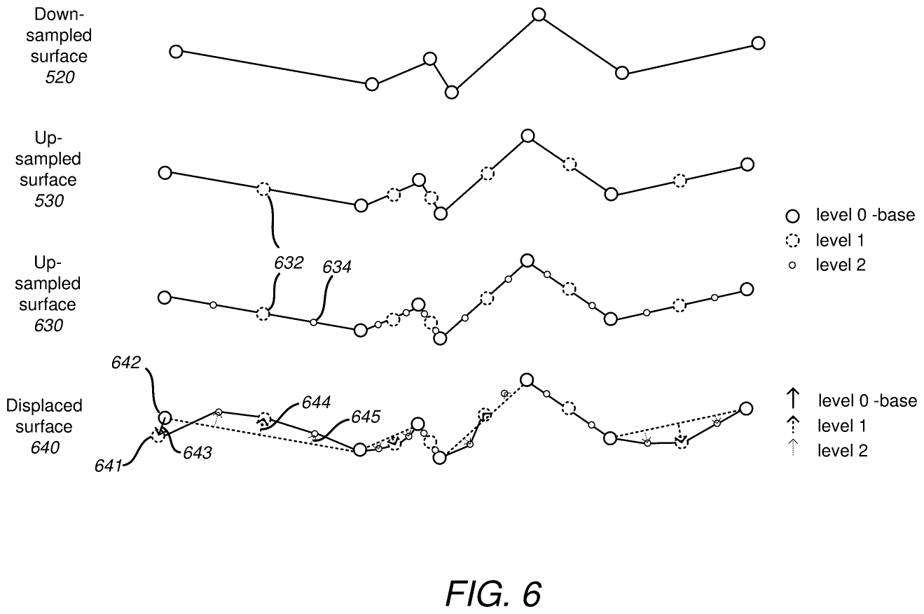

FIG. 6 illustrates an example of vertices of a subdivided mesh (e.g., a subdivided base mesh) corresponding to multiple levels of detail (LODs), according to some embodiments. As described above with respect to FIG. 5A, the subdivision process (e.g., subdivision scheme) may be an iterative process, in which a mesh can be subdivided multiple times and a hierarchical data structure is generated containing multiple levels. Each level of the hierarchical data structure may include different numbers of data samples (e.g., vertices and edges in mesh) representing (e.g., forming) different density/resolution (e.g., also referred to as levels of details (LoDs)). For example, a down-sampled surface 520 (of a decimated mesh) can be subdivided into up-sampled surface 530 after a first iteration of subdivision. Up-sampled surface 530 may be further subdivided into up-sampled surface 630 and so forth. In this case, vertices of the mesh with down-sampled surface 520 may be considered as being in or associated with LOD0. Vertices, such as vertex 632, generated in up-sampled surface 530 after a first iteration of subdivision may be at LOD1. Vertices, such as vertex 634, generated in up-sampled surface 630 after another iteration of subdivision may be at LOD2, etc. In some examples, an LOD0 may refer to the vertices resulting from decimation of an input (e.g., original) mesh resulting in a base mesh with (e.g., having) down-sampled surface 520. For example, vertices at LOD0 may be vertices of a reconstructed quantized base mesh 256 of FIGS. 2A-B, reconstructed/decoded base mesh 340 of FIG. 3, reconstructed base mesh 440 of FIG. 4.

In some examples, the computation of displacements in different LODs follows the same mechanism as described above with respect to FIG. 5A. In some examples, a displacement vector 643 may be computed from a position of a vertex 641 in the original surface 510 (of original mesh) to a vertex 642, from displace surface 640 of the deformed mesh, at LOD0. The displacement vectors 644 and 645 of corresponding vertices 632 and 634 from LOD1 and LOD 2, respectively, may be similarly calculated. Accordingly, in some examples, a number of iterations of subdivision may correspond to a number of LODs and one of the iterations may correspond to one LOD of the LODs.

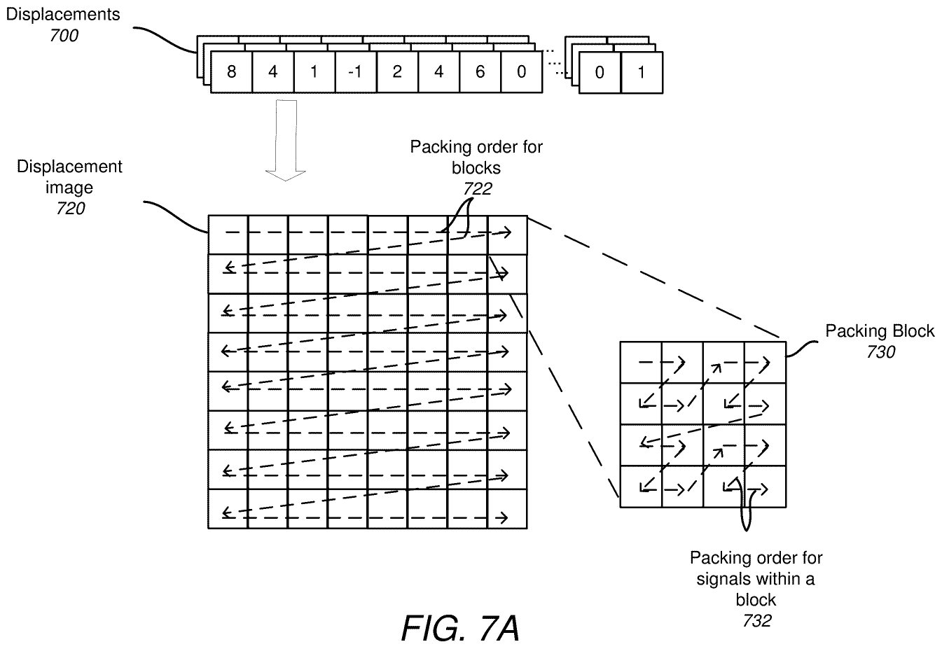

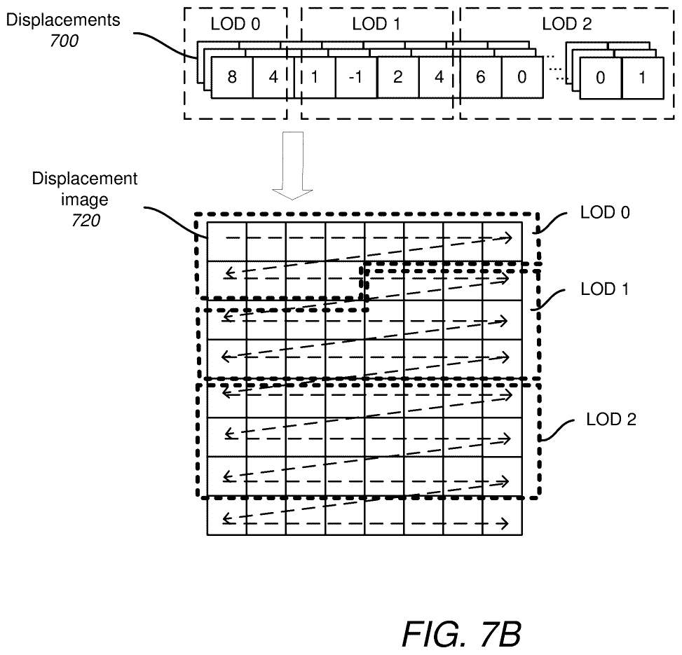

FIG. 7A illustrates an example of an image 720 (e.g., picture or a picture frame) packed with displacements 700 (e.g., displacement fields or vectors) using a packing method (e.g., a packing scheme or a packing algorithm), according to some embodiments. Specifically, displacements 700 may be generated, as described above with respect to FIGS. 5A-B and FIG. 6, and packed into 2D images. In some examples, a displacement can be a 3D vector containing the values for the three components of the distance. For example, a delta x value represents the shift on the x-axis from a point A to a point B in a Cartesian coordinate system. In some examples, a displacement vector may be represented by less than three components, e.g., by one or two components. For example, when a local coordinate system is used to store the displacement value, one component with the highest significance may be stored as being representative of the displacement and the other components may be discarded.

In some examples, as will be further described below, a displacement value may be transformed into other signal domains for achieving better compression. For example, a displacement can be wavelet transformed and be decomposed into and represented as wavelet coefficients (e.g., coefficient values or transform coefficients). In these examples, displacements 700 that are packed in image 720 may comprise the resulting wavelet coefficients (e.g., transform coefficients), which may be more efficiently compressed than the un-transformed displacement values. At the decoder side, a decoder may decode displacements 700 as wavelet coefficients and may apply an inverse wavelet transform process to reconstruct the original displacement values obtained at the encoder.

In some examples, one or more of displacements 700 may be quantized by the encoder before being packed into displacement image 720. In some examples, one or more displacements may be quantized before being wavelet transformed, after being wavelet transformed, or quantized before and after being wavelet transformed. For example, FIG. 7A shows quantized wavelet transform values 8, 4, 1, −1, etc. in displacements 700. At the decoder side, the decoder may perform inverse quantization to reverse or undo the quantization process performed by the encoder.

In general, quantization in signal processing may be the process of mapping input values from a larger set to output values in a smaller set. It is often used in data compression to reduce the amount, the precision, or the resolution of the data into a more compact representation. However, this reduction can lead to a loss of information and introduce compression artifacts. The choice of quantization parameters, such as the number of quantization levels, is a trade-off between the desired level of precision and the resulting data size. There are many different quantization techniques, such as uniform quantization, non-uniform quantization, and adaptive quantization that may be selected/enabled/applied. They can be employed depending on the specific requirements of the application.

In some examples, wavelet coefficients (e.g., displacement coefficients representing displacement signals) may be adaptively quantized according to LODs. As explained above, a mesh may be iteratively subdivided to generate a hierarchical data structure comprising multiple LODs. In this example, each vertex and its associated displacement belong to the same level of hierarchy in the LOD structure, e.g., an LOD corresponding to a subdivision iteration in which that vertex was generated. In some examples, a vertex at each LOD may be quantized according to corresponding quantization parameters that specify different levels of intensity/precision of the signal to be quantized. For example, wavelet coefficients in LOD 3 may have a quantization parameter with, e.g., 42 and wavelet coefficients in LOD 0 may have a different, smaller quantization parameter of 28 to preserve more detail information in LOD 0.

In some examples, displacements 700 may be packed onto the pixels in a displacement image 720 with a width W and a height H. In an example, a size of displacement image 720 (e.g., W multiplied by H) may be greater or equal to the number of components in displacements 700 to ensure all displacement information may be packed. In some examples, displacement image 720 may be further partitioned into smaller regions (e.g., squares) referred to as a packing block 730. In an example, the length of packing block 730 may be an integer multiple of 2.

The displacements 700 (e.g., displacement signals represented by quantized wavelet coefficients) may be packed into a packing block 730 according to a packing order 732. Each packing block 730 may be packed (e.g., arranged or stored) in displacement image 720 according to a packing order 722. Once all the displacements 700 are packed, the empty pixels in image 720 may be padded with neighboring pixel values for improved compression. In the example shown in FIG. 7A, packing order 722 for packing blocks may be a raster order and a packing order 732 for displacements within packing block 730 may be, for example, a Z-order. However, it should be understood that other packing schemes both for blocks and displacements within blocks may be used. In some embodiments, a packing scheme for the blocks and/or within the blocks may be predetermined. In some embodiments, the packing scheme may be signaled by the encoder in the bitstream per patch, patch group, tile, image, or sequence of images. Relatedly, the signaled packing scheme may be obtained by the decoder from the bitstream.

In some examples, packing order 732 may follow a space-filling curve, which specifies a traversal in space in a continuous, non-repeating way. Some examples of space-filling curve algorithms (e.g., schemes) include Z-order curve, Hilbert Curve, Peano Curve, Moore Curve, Sierpinski Curve, Dragon Curve, etc. Space-filling curves have been used in image packing techniques to efficiently store and retrieve images in a way that maximizes storage space and minimizes retrieval time. Space-filling curves are well-suited to this task because they can provide a one-dimensional representation of a two-dimensional image. One common image packing technique that uses space-filling curves is called the Z-order or Morton order. The Z-order curve is constructed by interleaving the binary representations of the x and y coordinates of each pixel in an image. This creates a one-dimensional representation of the image that can be stored in a linear array. To use the Z-order curve for image packing, the image is first divided into small blocks, typically 8×8 or 16×16 pixels in size. Each block is then encoded using the Z-order curve and stored in a linear array. When the image needs to be retrieved, the blocks are decoded using the inverse Z-order curve and reassembled into the original image.

In some examples, once packed, displacement image 720 may be encoded and decoded using a conventional 2D video codec.

FIG. 7B illustrates an example of displacement image 720, according to some embodiments. As shown, displacements 700 packed in displacement image 720 may be ordered according to their LODs. For example, displacement coefficients (e.g., quantized wavelet coefficients) may be ordered from a lowest LOD (e.g., LOD 0) to a highest LOD (e.g., LOD 2). In other words, a wavelet coefficient representing a displacement for a vertex at a first LOD may be packed (e.g., arranged and stored in displacement image 720) according to the first LOD. For example, displacements 700 may be packed from a lowest LOD to a highest LOD. Higher LODs represent a higher density of vertices and corresponds to more displacements compared to lower LODs. The portion of displacement image 720 not in any LOD may be a padded portion.

In some examples, displacements may be packed in inverse order from highest LOD to lowest LOD. In an example, the encoder may signal whether displacements are packed from lowest to highest LOD or from highest to lowest LOD.

In some examples, a wavelet transform may be applied to displacement values to generate wavelet coefficients (e.g., displacement coefficients) representing displacement signals that may be more easily compressed. Wavelet transforms are commonly used in signal processing to decompose a signal into a set of wavelets, which are small wave-like functions allowing them to capture localized features in the signal. The result of the wavelet transform is a set of coefficients that represent the contribution of each wavelet at different scales and positions in the signal. It is useful for detecting and localizing transient features in a signal and is generally used for signal analysis and data compression such as image, video, and audio compression.

Taking a 2D image as an example, a wavelet transform is used to decompose an image (signals) into two discrete components, known as predictions (e.g., also referred to as approximations) and details. The decomposed signals are further divided into a high frequency component (details) and a low frequency component (approximations/predictions) by passing through two filters, high and low pass filters. In the example of the 2D image, two filtering stages, a horizontal and a vertical filtering, are applied to the image signals. A down-sampling step is also required after each filtering stage on the decomposed components to obtain the wavelet coefficients resulting in four sub-signals in each decomposition level. The high frequency component corresponds to rapid changes or sharp transitions in the signal, such as an edge or a line in the image. On the other hand, the low frequency component refers to global characteristics of the signal. Depending on the application, different filtering and compression can be achieved. There are various types of wavelets such as Haar, Daubechies, Symlets, etc., each with different properties such as frequency resolution, time localization, etc.

In signal processing, a lifting scheme is a technique for both designing wavelets and performing the discrete wavelet transform (DWT). It is an alternative approach to the traditional filter bank implementation of the DWT that offers several advantages in terms of computational efficiency and flexibility. It decomposes the signal using a series of lifting steps such that the input signal, e.g., representing displacements for 3D meshes, may be converted to displacement coefficients in-place. In the lifting scheme, a series of lifting operations (e.g. lifting steps) may be performed. Each lifting operation involves a prediction step (e.g., prediction operation) and an update step (e.g., update operation). These lifting operations may be applied iteratively to obtain the wavelet coefficients.

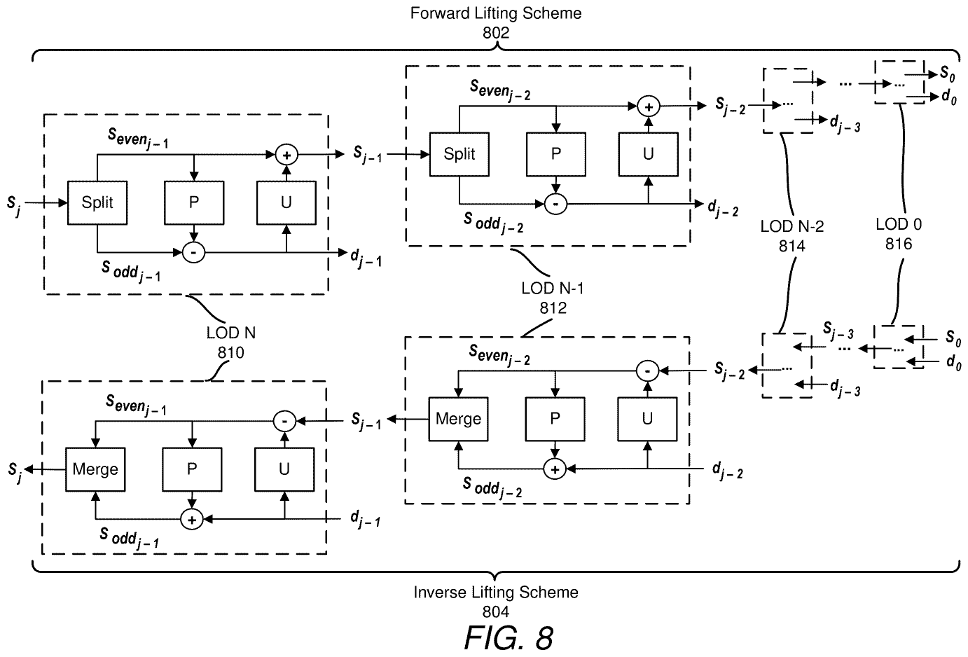

FIG. 8 illustrates an example of a lifting scheme for representing displacement information of a 3D mesh as wavelet coefficients, according to some embodiments. The lifting scheme may refer to a forward lifting scheme 802 and/or an inverse lifting scheme 804. The lifting scheme comprises a plurality of lifting operations, which may be iteratively performed. Each lifting operation may include a prediction operation (e.g., prediction step) and an update operation (e.g., an update step). An encoder may perform (e.g., apply) forward lifting scheme 802 to determine (e.g., derive, generate, or obtain) wavelet coefficients representing displacement information. A decoder may perform (e.g., apply) inverse lifting scheme 804 to reverse the operations of forward lifting scheme 802 to determine (e.g., derive, generate, or obtain) the displacement information from wavelet coefficients decoded from a bitstream. The decoded displacement information may include displacement values (e.g., displacement vectors) corresponding to vertices of a 3D mesh frame, which may be used by the decoder to generate a decoded mesh (e.g., a reconstructed mesh).

Forward lifting scheme 802 comprises a plurality of iterations corresponding to a plurality of LODs, e.g., shown as LOD_{N} 810, LOD_{N-1} 812, LOD_{N-2} 814, and LOD₀ 816. As explained above, each LOD may correspond to an iteration of subdivision. For example, vertices at an LOD are determined based on applying an iteration of a subdivision scheme. Each iteration of forward lifting scheme 802 (e.g., four iterations are shown as four dotted boxes corresponding to LODs 810-816) includes a splitting operation (e.g., a splitting step shown as a “Split” component), a prediction operation (e.g., a prediction step shown as a “P” component), and an update operation (e.g., an update step shown as a “U” component).

The splitting operation separates (or splits) signal sⱼ (j≥1) into two non-overlapping signals: the even samples denoted by sₑᵥₑₙ_{ₖ} (k∈[0, j−1]) and the odd samples denoted by s_{odd}_{ₖ}. Signal sⱼ represents the displacement values (e.g., displacement signals) determined for vertices of the 3D mesh frame. For example, a displacement value comprises a displacement field (e.g., a displacement vector), which may be one, two, or three components, as explained above. In each lifting operation iteration, the odd samples s_{odd}_{ₖ} include the displacement coefficients of vertices at an LOD corresponding to the iteration. For each odd sample of the odd samples s_{odd}_{ₖ}, the even samples sₑᵥₑₙ_{ₖ} may include the two displacement coefficients of the two vertices, of the 3D mesh frame, from which the vertex corresponding to the odd sample was generated during a mesh subdivision or down-sampling process, as explained above with respect to FIG. 6. Since vertices at the LOD are generated from vertices at lower LODs, the two vertices of the 3D mesh frame are at LODs that are lower than the LOD of the lifting operation iteration.

The prediction operation determines (e.g., computes) a prediction for the odd samples based on the even samples. For example, the prediction may be subtracted from the odd samples (e.g., shown as circles with negative signs) to generate a prediction error, e.g., error signal dₖ (k∈[0, j−1]). Forward lifting scheme 802 also includes an update operation that recalibrates the low-frequency signals (e.g., corresponding to signals at lower LODs) with some of the energy removed during the subsampling. In the case of classical lifting, this is used to prepare the even signals for the next prediction operation in the next iteration of forward lifting scheme 802. For example, the update operation updates (e.g., prepares) the even signals based on the error signal dₖ representing a difference between odd sample s_{odd}_{ₖ} and a corresponding predicted odd sample. In some examples, the update operation may update the even signal sₑᵥₑₙ_{ₖ} based on adding the prediction error dₖ to the even signal sₑᵥₑₙ_{ₖ} (e.g., shown as circle with positive signs). In some examples, the prediction error dₖ may be adjusted by an update weight, and the even signal may be updated based on the adjusted prediction error. For example, the update weight may be determined based on the LOD of the odd sample s_{odd}_{ₖ}. For example, an indication of the update weight may be signaled in the bitstream from the encoder to the decoder for each LOD.

In some embodiments, a decoder performs inverse lifting scheme 804 to reverse the operations of forward lifting scheme 802. For example, whereas forward lifting scheme 802 comprises lifting operations that are iteratively performed from higher LODs (e.g., LOD_{N} 810) to lower LODs (e.g., LOD₀ 816), inverse lifting scheme 804A comprises lifting operations that are iteratively performed from lower LODs (e.g., LOD₀ 816) to higher LODs (e.g., LOD_{N} 810). Each iteration of inverse lifting scheme 804 (e.g., four iterations are shown as four dotted boxes corresponding to LODs 810-816) includes an update operation (e.g., an update step shown as a “U” component), a prediction operation (e.g., a prediction step shown as a “P” component), and a merge operation (e.g., a merge step shown as a “Merge” component).

Different from forward lifting scheme 802, an update operation, in each lifting operation of inverse lifting scheme 804, may update the even signals sₖ (e.g., corresponding to transformed displacement coefficients) by subtracting prediction error dₖ (corresponding to odd signals at the LOD corresponding to the lifting operation iteration) from the even samples to determine the updated even samples sₑᵥₑₙ_{ₖ}. In some examples, the prediction error dₖ may be adjusted by an update weight and the even samples may be updated based on the adjusted prediction error. In some examples, the update operation may be performed according to an update scheme. For example, the update scheme may be one of various schemes such as a default update (e.g., with constant weight), an LOD-based update, a valence-based update, a similarity-based prediction, a normal-based update, or a combination thereof etc.

A prediction operation, in each lifting operation of inverse lifting scheme 804A, may determine a reconstructed predicted odd sample s_{odd}_{ₖ} based on the updated even samples sₑᵥₑₙ_{ₖ}. In some examples, the prediction operation may be performed according to a prediction scheme. For example, the prediction scheme may be one of various schemes such as an average prediction, a similarity-based prediction, a normal-based prediction, or a combination thereof etc. For example, the prediction operation may be performed using an average prediction scheme, in which an average of two updated even samples sₑᵥₑₙ_{ₖ} is determined to generate a prediction of a reconstructed odd sample.

Each lifting operation of inverse lifting scheme 804 combines or sums (e.g., shown as circles with positive signs) the reconstructed predicted odd sample with the prediction error dₖ to determine (e.g., generate or obtain) a displacement signal s_{odd}_{ₖ} corresponding to a displacement value determined at the encoder. In other words, the plurality of iterations of inverse lifting scheme 804 converts the wavelet coefficients (displacement coefficients), generated by the encoder and representing displacement information, into displacement values that may be used to reconstruct the (3D) mesh frame. Further, to revert the splitting operation of forward lifting scheme 802, each lifting operation of inverse lifting scheme 804A includes a merge operation that merges (e.g., orders or combines as a sequence of signals or values) the updated even samples sₑᵥₑₙ_{ₖ} with the reconstructed odd sample s_{odd}_{ₖ}.

Note that the value j in FIG. 8 corresponds to a number of iterations for the lifting operations which varies depending on the specific requirement of the application for 3D meshes. For example, the number of levels in LOD defined by the mesh decimation process may be used for the lifting operations. In some examples, a mid-point subdivision scheme may be used in the mesh decimation process. In these examples, since each vertex in a higher LOD level is a generated mid-point of an edge defined by two vertices in lower LOD levels, the signal (e.g., displacement value or its wavelet coefficient representation) associated with that vertex may be decomposed and represented by two sub-signals (e.g., displacement values or their wavelet coefficient representations) which belong to the corresponding two vertices. For example, a vertex v in LOD₁ (e.g., an LOD of level 1) may be the mid-point of the edge defined by two vertices v₁ and v₂ in LOD₀ (e.g., an LOD of level 0). In this example, the displacement associated with v can be wavelet transformed by using the lifting scheme. For an odd signal s_{odd}_{ₖ} corresponding to vertex v (e.g., the signal being the displacement signal or its wavelet coefficient representation), the even samples sₑᵥₑₙ_{ₖ} determined for odd signal s_{odd}_{ₖ} may correspond to vertices v₁ and v₂ (e.g., the signals being displacement signals or their wavelet coefficient representations) from which vertex v was generated.

In the lifting scheme, prediction weight and update weight are the values used to modify the input data during the prediction and update steps, respectively. The prediction weight may be a scalar value or a set of coefficients that define the linear combination of the neighboring signals used for prediction while the update weight determines the contribution of the prediction error to the final updated value. For example, the prediction may be determined from two input even samples using an average prediction scheme in which a prediction weight is equal to one half, which effectively averages signal values of the two input even samples. The prediction and update weights are often selected to satisfy certain properties or conditions to achieve desired characteristics in the transformed data. For example, in lossless lifting schemes, the weights may be designed to ensure perfect reconstruction of the original signal. In lossy lifting schemes, the weights may be selected to achieve specific frequency response characteristics or to minimize distortion based on the compression or denoising requirements.

In some implementations of the lifting scheme, the prediction weight and the update weight may be determined (e.g., selected), applied to displacements for vertices of a 3D mesh (e.g., each mesh frame of a sequence of mesh frames), such as to balance accuracy and properties resulting from the wavelet transforms corresponding to the displacements. As explained above, prediction operations of each iteration of the inverse lifting scheme may be dependent on (e.g., impacted by) updated signals inputs to the prediction operation. In the default update scheme, the update weight may be a value (e.g., ⅛, ¼, or 1/16, etc.) selected to be uniformly applied to wavelet coefficients corresponding (e.g., representing) the displacements. Due to characteristics and geometry of the mesh frame, characteristics at each LOD may not be the same. Therefore, applying the same update weight may results in reduced compression for displacements (e.g., displacement signals) for vertices at certain LODs.

In some embodiments, adaptive update weights in the lifting scheme are applied to displacements for vertices of 3D meshes (e.g., mesh frames of a sequence of mesh frames of a 3D mesh). For example, instead of the default update scheme, an LOD-based update scheme may be used to generate update weights for the forward and inverse lifting transforms. In the LOD-based update scheme, an update weight for each wavelet coefficient may be determined based on an LOD associated with that wavelet coefficient. As explained above, the lifting scheme may include a plurality of lifting operations corresponding to a plurality of LODs in the 3D mesh (e.g., mesh frame). For a forward lifting scheme, each iteration of the lifting operation may update (e.g., lift) a sequence of displacement signals (e.g., displacement values or corresponding wavelet coefficients representing the displacement values) from a higher LOD (e.g., denser vertices) to one or more lower LODs (e.g., sparser vertices) and accumulate the prediction towards vertices at the lowest LOD (e.g., vertices of the base mesh). Similarly, for an inverse lifting scheme, each iteration of the lifting operation may update (e.g., lift) a sequence of displacement signals (e.g., displacement values or corresponding wavelet coefficients representing the displacement values) from lower LOD (e.g., sparser vertices) to higher LODs (e.g., denser vertices). Since the update weight determines the amount of contribution of the prediction error to the final updated value, adapting uniform weight values to consider the impact of different LOD levels may result in more accurate predicting signals across different LOD levels. In some examples, lower LODs may be associated with smaller update weights and higher LODs may be associated with larger update weights. In some examples, lower LODs may be associated with larger update weights and higher LODs may be associated with smaller update weights.

As explained above, as part of encoding and decoding a 3D mesh, a subdivided mesh is generated from a base mesh using one or more subdivision schemes. For example, the base mesh may be iteratively subdivided to generate the subdivided mesh. Then, displacements of vertices of the subdivided mesh are generated and encoded by the encoder in a bitstream, from which a decoder obtains and decodes the displacements to reconstruct the 3D mesh.

Each iteration of subdivision corresponds to another LOD. In other words, vertices of the base mesh may correspond to a first LOD with the lowest index (e.g., LOD 0 shown in FIG. 7B). After subdividing the base mesh to generate new first vertices of a first subdivided mesh, the new first vertices may correspond to a second LOD with an incremented index (e.g., LOD 1 shown in FIG. 7B). Vertices of a next LOD may be obtained by further subdividing the first subdivided mesh to determine a second subdivided mesh, etc. Accordingly, as shown in FIG. 7B, indexes of vertices increase for higher LODs and correspond to higher iteration number of iterations of subdivision.

In some embodiments, during the subdivision process, vertex information is generated that associates each vertex (e.g., by a vertex index) with an edge that was subdivided to generate that vertex. For example, an index of a vertex to a table/list of vertices may indicate a pair of vertices (from a lower LOD) forming the edge that was subdivided. As part of performing the lifting wavelet transform scheme for encoding/decoding displacements at vertices, the pair of vertices may correspond to the even signals/samples used to predict the odd signal/sample corresponding to the vertex generated from the pair of vertices, as explained above with respect to FIG. 8.

In some embodiments, a subdivision scheme may be applied in an iteration of subdivision. The subdivision scheme may be one of a plurality of subdivision schemes. For example, the plurality of subdivision schemes may include one or more of the following example schemes: a midpoint subdivision using an arithmetic mean (referred to as “mid” subdivision), a midpoint subdivision using a harmonic mean, a loop subdivision, an LS3 subdivision, a Butterfly subdivision, a normal-based subdivision, etc.

In some embodiments, each iteration of iterations of subdivision to obtain the subdivided mesh from the base mesh may select one of the plurality of subdivision schemes. For example, two iterations of the iterations may apply different subdivision schemes to generate the final subdivided mesh.

In some examples, the selection of subdivision scheme for each iteration of subdivision may be predetermined (e.g., using mid-mid-loop or normal-normal-loop for 3 iterations corresponding to 3 LODs).

In some examples, the encoder may select a subdivision scheme for each iteration/LOD and signal the selected subdivision scheme per LOD in the bitstream to the decoder.

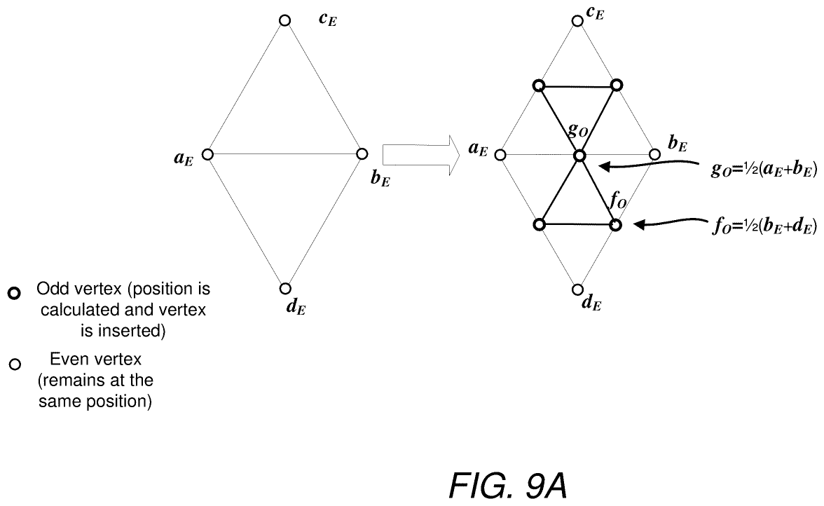

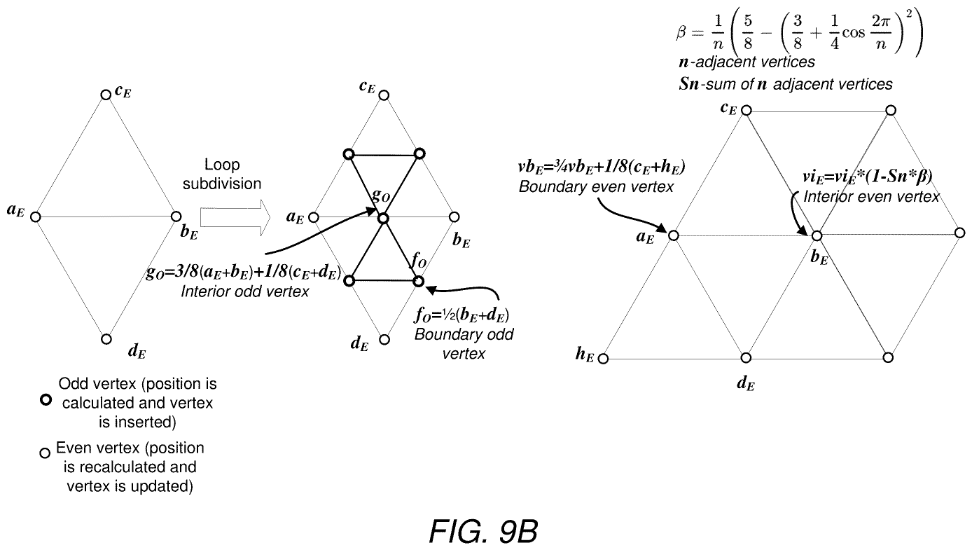

FIG. 9A illustrates an example of midpoint subdivision, according to some embodiments. In midpoint subdivision, odd vertices are generated from pairs of the even vertices based on the midpoint of an edge formed by a pair of even vertices. For example, an odd vertex g0 is determined as a midpoint of the edge formed by vertex a_{E} and a_{B}. In other words, the odd vertex g0 may be determined as an average of vertex a_{E} and a_{B}.

FIG. 9B illustrates an example of loop subdivision, according to some embodiments. In contrast to midpoint subdivision, new positions are calculated for both odd and even vertices. As shown in FIG. 9B, interior and boundary odd vertices are generated according to different weights of edges. And, interior and boundary even vertices are also adjusted according to different weights. Accordingly, positions of both existing and new vertices are adjusted by performing weighted sum operations on adjacent vertices and the current vertex. The loop subdivision scheme generally results in smoother surfaces.

In some embodiments, a Least Squares Subdivision Surfaces-LS3 subdivision scheme involves three steps: splitting to add new vertices, relaxation to smooth them, and projection onto an algebraic surface for refinement. This scheme improves the smoothness and visual quality of 3D polygonal meshes, especially around complex areas.

In some embodiments, a normal-based subdivision scheme enhances the subdivision process by incorporating normal vectors. This scheme generates the new subdivision point by introducing an additional term, known as the refinement vector, which is derived from the normal vectors of the vertices used in the subdivision. Other subdivision schemes further enhance the normal-based subdivision scheme.

In some embodiments, an adaptive-mean subdivision scheme uses a normal-based condition to adaptively decide between the harmonic mean and arithmetic mean when subdividing edges in an iteration of subdivision. The dot product of normal vectors from adjacent triangles (to the mesh edge) determines whether to apply the harmonic or arithmetic mean for each edge during subdivision.

In some embodiments, displacements at the vertices of the subdivided mesh are signaled with respect to normalized vertex normals of the vertices, respectively. A vertex normal of a vector may be a directional vector associated with the vertex and representing a geometric normal of the surface at the vertex. The vertex normal may be normalized to be a unit normal vector by dividing the normal vector by a length of the normal vector. In some examples, a displacement at a vertex may be signaled as a scalar value representing a magnitude of the normalized vertex normal. For example, a displacement vector may be determined as a product of the scalar value and the normalized vector normal (i.e., unit normal vector) at the vertex.

Accordingly, in some embodiments, before computing displacements of vertices of a 3D mesh at the encoder and the decoder, normalized vector normals at the vertices of the subdivided need to be derived. As explained above with respect to FIGS. 5A-B and 6, a vertex normal at a vertex may be obtained based on combining (e.g., averaging or a weighted average) of face normals of the faces that contains the vertex. Then, the vertex normal may be normalized to determine the unit normal vector. However, the faces are not known until the all n iterations of subdivision, corresponding to n+1 LODs, have been completed and the subdivided mesh is obtained.

In some implementations, to enable partial reconstruction of the 3D mesh such that less than n iterations of subdivision are performed to reconstruct the 3D mesh, a normal interpolation technique can be applied to interpolate a vertex normal of a vertex from vertex normals of neighboring vertices, of the vertex, from lower LODs than an LOD of the vertex. For example, the neighboring vertices may be the two vertices forming an edge that is subdivided to generate (e.g., derive) the vertex. It should be noted that in the following descriptions, reference to a vertex normal of a vertex may refer to a normalized vertex normal (i.e., the unit normal vector) at the vertex. The unit normal vector is a vector with a length equal to one.

Enabling the functionality of partial reconstruction of the 3D mesh based on less than all of the LODs may permit different levels of mesh resolution. For example, the capability to decrease the number of iterations of subdivision, which corresponds to fewer LODs, results to lower resolution, but less bandwidth and runtime complexity.

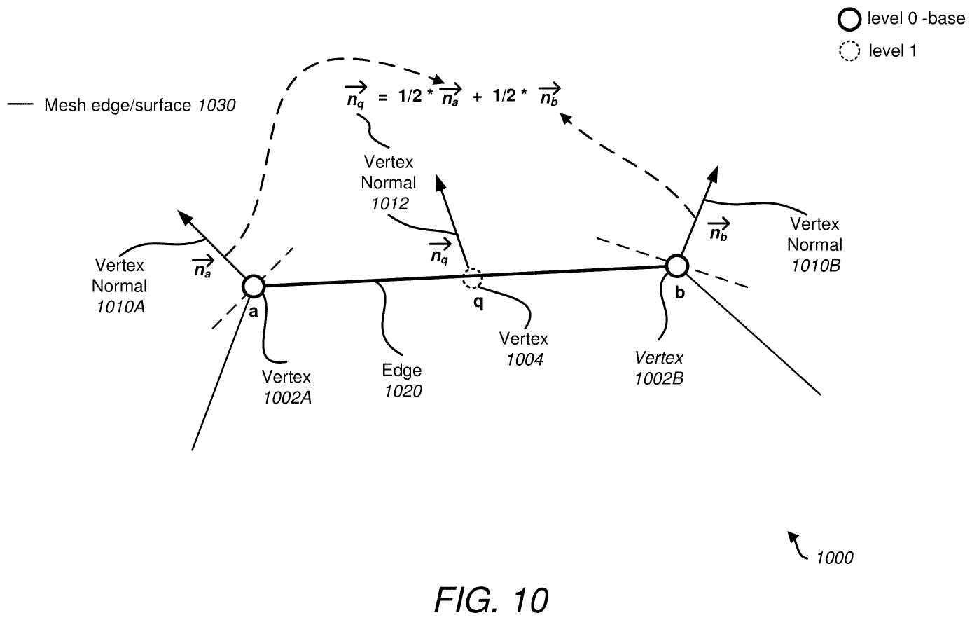

FIG. 10 shows an example diagram 1000 of normal interpolation to derive a vertex normal 1012 of a vertex 1004 from neighboring vertices 1010A-B of the vertex 1004, according to some embodiments. Since both the encoder and decoder need to identically generate a same subdivided mesh, from iteratively subdividing a base mesh, and vertex normals of vertices of the subdivided mesh to permit the decoder to identically reconstruct a 3D mesh from displacement information, the normal interpolation process may be performed separately and identically at the encoder and the decoder.

In some examples, neighboring vertices 1010A-B may form an edge 1020 (of a mesh edge/surface 1030) that was subdivided to generate vertex 1004. The neighboring vertices 1010A-B may be obtained for vertex 1004, e.g., based on an index of vertex 1004. For example, an index of vertex 1004 may point to the pair of vertices 1010A-B forming edge 1020. Vertices 1010A-B are at lower LODs than an LOD of vertex 1004 and were from the base mesh or resulting from a previous iteration of subdividing the base mesh.

In some examples, vertex 1004 may be generated from vertices 1010A-B using a mid-point subdivision scheme with an arithmetic mean. For example, vertex 1004 (q) may be determined as an average of vertices 1010A-B (a, b), i.e., the position of vertex 1004 is the average of the positions of vertices 1010A-B (a, b).

Vertex normal 1012 (\vec{n_{q}}) of vertex 1004 (q) may be interpolated from vertex normals 1010A-B (\vec{nₐ}, \vec{n_{b}}) of respective vertices 1010A-B (a, b) by averaging the vertex normals 1010A-B as follows:

$$\vec{{n}_{q}} = \frac{1}{2} \vec{{n}_{a}} + \frac{1}{2} \vec{{n}_{b}} \qquad ( Eq . 4 )$$

In some examples, this vertex normal interpolation process permits partial reconstruction as well as lower selectable resolution of the 3D mesh because vertices of all the LODs of the 3D mesh need not to be processed first before encoding and decoding displacement information/signals at vertices of the 3D mesh. However, interpolating vertex normal based on averaging vertex normals does not consider the varying surface curvature characteristics of the 3D mesh across the LODs corresponding to vertices generated at each subdivision of a subdivided mesh used to encode/decode the 3D mesh.

Moreover, one or more iterations of the subdivision of the base mesh may use subdivision schemes that are not mid-point subdivision. Examples of possible subdivision schemes may include a midpoint subdivision scheme using an arithmetic mean, a midpoint subdivision using a harmonic mean, a loop subdivision, an LS3 subdivision, a Butterfly subdivision, a normal-based subdivision, etc. In fact, the base mesh may be iteratively subdivided using different subdivision schemes, which results in vertices of different LODs being generated using different subdivision schemes. Performing vertex normal interpolation based on averaging vertex normals of neighboring vertices is not optimal for all types of subdivision schemes.

In some embodiments, interpolation of normal vectors may be enhanced by adaptively selecting one or more interpolation weights for neighboring vertices of a vertex to derive a vertex normal (e.g., a unit vertex normal) of the vertex. For example, the vertex normal may be determined by combining vertex normals of the neighboring vertices according to the one or more interpolation weights. In some embodiments, one or more indications may be signaled in the bitstream to indicate the one or more interpolation weights. For example, to interpolate a vertex normal of a vertex from a first and second vertex normal of a first and second vertex, neighboring the vertex, the one or more interpolation weights may be used to determine a first interpolation weight for the first vertex normal and a second interpolation weight for the second vertex normal. Accordingly, the vertex normal of the vertex may be determined as a linear combination of the first and second vertex normals with the first and second vertex normals being weighted by the first and second interpolation weights, respectively.

In some examples, the one or more interpolation weights indicates a single interpolation weight corresponding to a lower vertex index of the first and second vertex normals. For example, the single interpolation weight may be the first interpolation weight for the first vertex based on a first index of the first vertex being lower than a second index of the second vertex. In some examples, the second interpolation weight may be determined as the difference of one and the first interpolation weight.

In some example, the one or more interpolation weights may be signaled for a portion of vertices of the 3D mesh (e.g., a patch, submesh, corresponding to an LOD, etc.).

In some examples, the one or more interpolation weights may be signaled for respective subdivision schemes of the plurality of subdivision scheme. For example, a table of interpolation weights may be signaled to corresponding each subdivision scheme with one or more respective interpolation weights.

By signaling separate interpolation weights, the interpolated vertex normals for vertices may be closer to the surface curvature of the 3D mesh, which results in both lower displacement residuals and higher reconstruction quality.

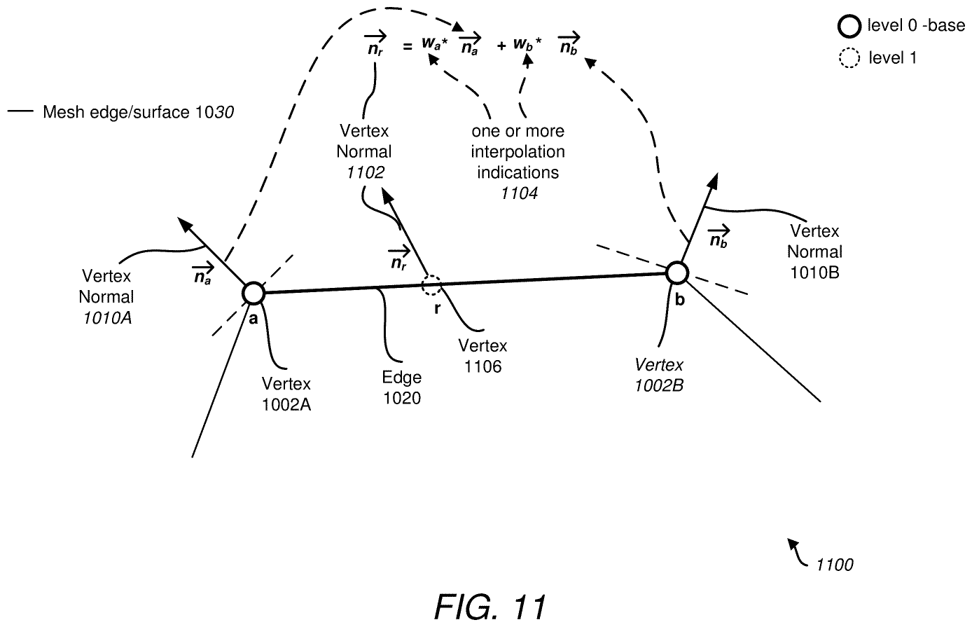

FIG. 11 shows an example diagram 1100 of normal interpolation with adaptive interpolation weights to derive a vertex normal 1102 of a vertex 1106 from neighboring vertices 1010A-B of the vertex 1004, according to some embodiments. Diagram 1100 shows an example of applying adaptive interpolation for a vertex 1106 generated from subdividing edge 1020 of FIG. 10. Similar to FIG. 10, since both the encoder and decoder need to identically generate a same subdivided mesh, from iteratively subdividing a base mesh, and vertex normals of vertices of the subdivided mesh to permit the decoder to identically reconstruct a 3D mesh from displacement information, the adaptive normal interpolation process may be performed separately and identically at the encoder and the decoder.

In some examples, neighboring vertices 1010A-B may form an edge 1020 (of a mesh edge/surface 1030) that was subdivided to generate vertex 1106. For example, vertex 1106 may be generated based on applying a midpoint subdivision scheme with an arithmetic mean, which results in vertex 1106 being the same as vertex 1004 of FIG. 10. However, vertex 1106 may be generated by applying other types of subdivision schemes so that vertex 1106 is not the same as vertex 1004.

The neighboring vertices 1010A-B may be obtained for vertex 1106, e.g., based on an index of vertex 1106. For example, an index of vertex 1106 may point to the pair of vertices 1010A-B forming edge 1020. Vertices 1010A-B are at lower LODs than an LOD of vertex 1106 and were from the base mesh or resulting from a previous iteration of subdividing the base mesh.

In some embodiments, vertex normal 1112 (\vec{nᵣ}) of vertex 1106 (r) may be interpolated from vertex normals 1010A-B (first vertex normal \vec{nₐ}, second vertex normal \vec{n_{b}}) of respective vertices 1010A-B (first vertex a, second vertex b) by combining the vertex normals 1010A-B according to respective interpolation weights (first interpolation weight wₐ, second interpolation weight w_{b}), indicated by one or more interpolation indications, as follows:

$$\vec{{n}_{r}} = {w}_{a} * \vec{{n}_{a}} + {w}_{a} * \vec{{n}_{b}} \qquad ( Eq . 5 )$$

In some embodiments, one or more interpolation indications 1104 may be signaled in the bitstream by the encoder. The decoder may obtain (e.g., derive) the first and second interpolation weights (wₐ, w_{b}) based on obtaining (e.g., decoding) the one or more interpolation indications 1104 from the bitstream.

In some embodiments, one or more interpolation indications 1104 may include an indication of whether adaptive interpolation is used (e.g., enabled or activated). For example, this indication may be an interpolation mode indication that is signaled for a 3D mesh sequence, a 3D mesh frame in the sequence, a tile in the 3D mesh frame, a patch of the 3D mesh, a submesh of the 3D mesh, an LOD associated with the 3D mesh, etc. The interpolation mode indication may be a binary flag that indicates whether adaptive interpolation is enabled or disabled.

In some examples, the interpolation mode indication may be signaled for each respective subdivision scheme for a plurality of subdivision scheme. For example, the encoder may compare using adaptive interpolation weights with fixed weights (e.g., ½) for each of the subdivision schemes and signal the interpolation mode indication to indicate which subdivision schemes are associated with the adaptive interpolation with signaled interpolation weights.

In some embodiments, one or more interpolation indications 1104 may include one or more indications that indicate values of the first and second interpolation weights (wₐ, w_{b}). For example, the one or more indications may include a first indication of a value of the first interpolation weight (wₐ). Various examples of the indication of the value are described below.

For example, the first indication may include a magnitude of the first interpolation weight (wₐ).

For example, the first indication may include an index to a set/list of interpolation weights and the value of the first interpolation weight may correspond to one of the set of interpolation weights indicated by the index.

For example, the first indication may include a log 2 value of the first interpolation weight (wₐ).

For example, the first indication may indicate a numerator value and a denominator value in a fraction. The first interpolation weight (wₐ) may be determined (e.g., derived) as the fraction with the numerator value and the denominator value.

For example, the first indication may indicate an offset from a predetermined weight to indicate the first interpolation weight (wₐ). For example, the first indication may include a sign indicator (W_{sign}) and a magnitude indicator (W) used to derive the sign and the magnitude of the offset. For example, the following process shows one example of deriving the value of the first interpolation weight (wₐ) based on an offset derived from the sign indicator (W_{sign}) and the magnitude indicator (W) that indicates a value representing a log 2 value:

$${w}_{a} = ( {W}_{s i g n} == 0 ? 1 : - 1 ) * {( \frac{1}{2} )}^{W} + 0.5 \qquad ( Eq . 6 )$$

For example, for W=5, W_{sign}=1 (e.g., 0 is positive, 1 is negative), the first interpolation weight (wₐ) may be determined as follows:

$${w}_{a} = ( - 1 ) * {( \frac{1}{2} )}^{5} + 0.5 = 0.46875 \qquad ( Eq . 7 )$$

In some embodiments, the one or more indications that indicate values of the first and second interpolation weights may further include a second indication of value of the second interpolation weight (w_{b}). The second indication may be signaled in the same way as the first indication described above.

In some embodiments, the one or more indications that indicate values of the first and second interpolation weights include the first indication and not the second indication. For example, the second interpolation weight may equal a difference of one and the first interpolation weight. Therefore, a decoder may derive the second interpolation after deriving the first interpolation weight based on the first indication obtained from the bitstream.

In some embodiments, values of the first and second interpolation weights may be derived by the encoder based on, e.g., the subdivision scheme, LOD of vertices for which the vertex normals are to be interpolated, and/or rate distortion optimization (RDO) metrics for coding displacements based on different first and second interpolation weights. Then, the encoder may signal one or more interpolation indications 1104 in the bitstream to indicate the derived first and second interpolation weights to the decoder.

In some embodiments, the one or more interpolation indications 1104 may be signaled in the bitstream for each LOD such that vertex normals of vertices at that LOD are derived according to the one or more interpolation indications 1104.

In some embodiments, the one or more interpolation indications 1104 may be signaled in the bitstream for each subdivision scheme of a plurality of subdivision schemes. In these embodiments, for vertices at each LOD, the vertex normals for these vertices may be interpolated according to one or more interpolation indications 1104 associated with the subdivision scheme used to generate the vertices at the LOD.

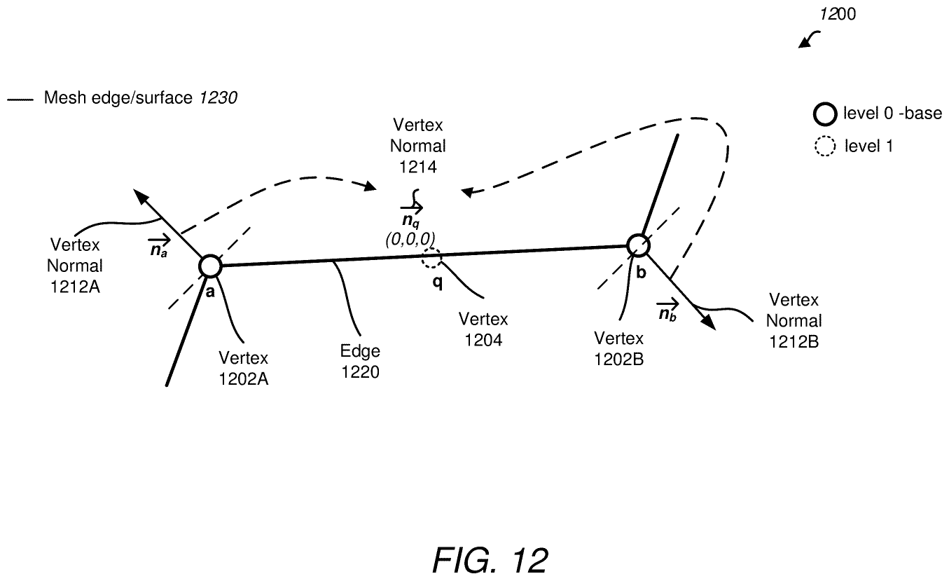

FIG. 12 is a diagram 1200 showing an example of normal interpolation in which a vertex normal 1214 for vertex 1204 is determined to be zero, according to some embodiments. For example, vertex normal 1214 may be determined (e.g., derived) by combining vertex normals 1212A-B of vertices 1202A-B neighboring vertex 1204, according to a normal interpolation process such as that described in FIGS. 10-11. As explained above with respect to FIGS. 10-11, vertices 1202A-B may be associated with generating vertex 1204 during an iteration of subdivision of the base mesh. For example, vertices 1202A-B may form edge 1220, of a mesh edge/surface 1230, that was subdivided to generate vertex 1204.

In some examples, the normal interpolation process may result in vertex normal 1214 being the null vector when vertex normals 1212A-B are antiparallel vectors. Two vectors are antiparallel vectors if they point in opposite directions and have an angle of 180° between them. With respect to the interpolation process of FIG. 10, vertex normal 1214 may be interpolated as the null vector when vertex normals 1212A-B are opposite vectors, which are a type of antiparallel vectors. For example, antiparallel vectors do not necessarily have the same magnitudes, while opposite vectors are antiparallel vectors that do have the same magnitudes.

In some embodiments, vertex normals 1212A-B and vertex normal 1214 are unit vectors. In these embodiments, vertex normals 1212A-B being antiparallel vectors would also make them opposite vectors.

As explained above with respect to FIGS. 5A-B and 6, vertex normals may be used in the computation of displacements at the encoder and used by the decoder to reconstruct displacements. Therefore, generating null vectors as normal vectors at vertices would permit only null displacements at these vertices and may result in lower quality reconstructed meshes. Further, normal vectors at vertices of the subdivided mesh are also used in the rendering attributes at the vertices such as reflectance/lighting, shading, etc., which may induce visual artifacts if attribute values are null due to normal vectors being null.

Embodiments described are related to deriving non-zero vertex normals of vertices of a subdivided mesh used to encode/decode a 3D mesh. As part of determining vertex normals for vertices of a subdivided mesh used to encode/decode a 3D mesh, a first and second vertex, of the vertices, associated with the vertex may be obtained. For example, the first and second vertices may form or represent an edge that was subdivided to generate the vertex. In some examples, based on a first vertex normal of the first vertex and a second vertex normal of the second vertex satisfying one or more conditions, a vertex normal of the vertex is determined that is perpendicular to at least one of the first vertex normal and the second vertex normal. In an example, the vertex normal that is determined is perpendicular to both the first and second vertex normals.

In some examples, the one or more conditions include the first vertex normal and the second vertex normal being antiparallel vectors (e.g., opposite vectors).

In some examples, the one or more conditions include the first vertex normal and the second vertex normal being combined to determine a candidate vertex normal of the vertex that is the null vector. For example, the first and second vertex normals may be combined in an interpolation process such as any of those described with respect to FIGS. 10-11.

In some examples, vertex normals for the vertices may be generated per LOD from vertices at the lowest LOD (e.g., vertices of the base mesh) to vertices at the highest LOD. Vertex normals of vertices at an LOD may be interpolated based on vertex normals of vertices from lower LODs corresponding to lower number iterations of subdivision. By ensuring interpolated vertex normals are non-zero and replacing them with non-zero, perpendicular vertex normals, displacements and attributes may be more accurately encoded/decoded to enable reconstructed 3D mesh of higher visual quality with less visual artifacts.

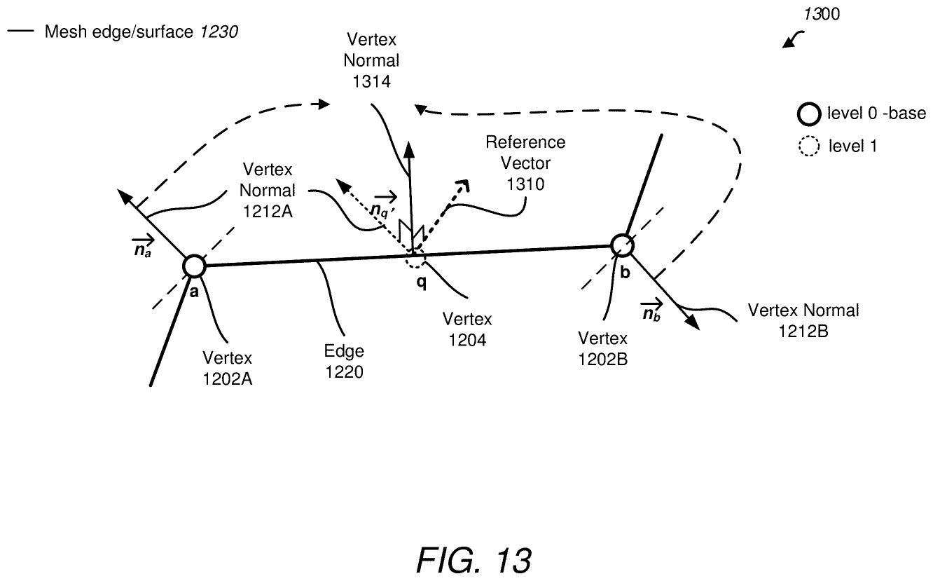

FIG. 13 illustrates a diagram 1300 of deriving a non-zero vertex normal 1314, for the vertex 1204 of FIG. 13, that is perpendicular to at least one of vertex normals 1212A-B of vertices 1202A-B, according to some embodiments. Diagram 1300 shows an example of resolving the null vector, vertex normal 1214 of FIG. 12, obtained from interpolation using vertex normals 1212A-B of vertices 1202A-B. For example, vertices 1202A-B may form edge 1220 used to generate vertex 1204 during an iteration of subdivision. The derivation process of normal vertex 1314 may be performed identically at the encoder and the decoder to permit the 3D mesh to be identically reconstructed at the encoder and the decoder.

In some examples, the determination of whether to generate the non-zero vertex normal 1314 may include determining whether vertex normal 1212A and vertex normal 1212B are antiparallel vectors (e.g., opposite vectors). For example, a dot product of vertex normal 1212A and vertex normal 1212B may be used to determine whether they are antiparallel vectors. In some examples, the dot product being −1 (or within a predetermined threshold of −1) indicates that the first and second vertex normals are antiparallel vectors (or substantially antiparallel vectors if within the predetermined threshold).

In some examples, the determination of whether to generate the non-zero vertex normal 1314 may include determining whether a combination of vertex normal 1212A and vertex normal 1212B results in a candidate vertex normal of the vertex that is the null vector. For example, vertex normals 1212A-B may be combined in an interpolation process such as any of those described with respect to FIGS. 10-11.

In some embodiments, determining (e.g., deriving) vertex normal 1314 that is perpendicular to at least one of vertex normals 1212A-B may include determining a reference vector 1310 that is noncollinear with at least one of vertex normals 1212A-B. In some examples, reference vector 1310 is determined that is noncollinear with both vertex normals 1212A-B.

In some examples, reference vector 1310 is determined (e.g., selected) to be not the same as the first vertex normal and not the same as the opposite of the first vertex normal.

In some examples, reference vector 1310 is selected to be a vector formed by vertex 1202A and vertex 1202B, e.g., indicating a displacement from vertex 1202A to vertex 1202B or indicating a displacement from vertex 1202B to vertex 1202A.

In some examples, reference vector 1310 is selected from one of the three standard unit vectors (i.e., standard basis vectors) in 3D space. For example, the standard unit vectors may be checked in a predetermined order to determine a standard unit vector that is noncollinear with at least one of vertex normals 1212A-B.

In some examples, the check may be performed by identifying whether a component of the first vertex normal is equal to one. If the component is identified, the reference vector is determined (e.g., selected) as one of the standard unit vectors with a corresponding component, as the identified component, that does not equal to one (e.g., that equals 0).

In some examples, vertex normal 1314 may be determined for vertex 1204 based on a cross product between reference vector 1310 and one of vertex normals 1212A-B. For example, the cross product may be between reference vector 1310 and a reference vertex normal that is a vertex normal (e.g., vertex normal 1212A) associated with a vertex (e.g., vertex 1202A) of vertices 1202A-B having a lower vertex index. It should be understood the cross product may be of reference vector 1310 and the reference vertex normal or of the reference vertex normal and reference vector 1310.

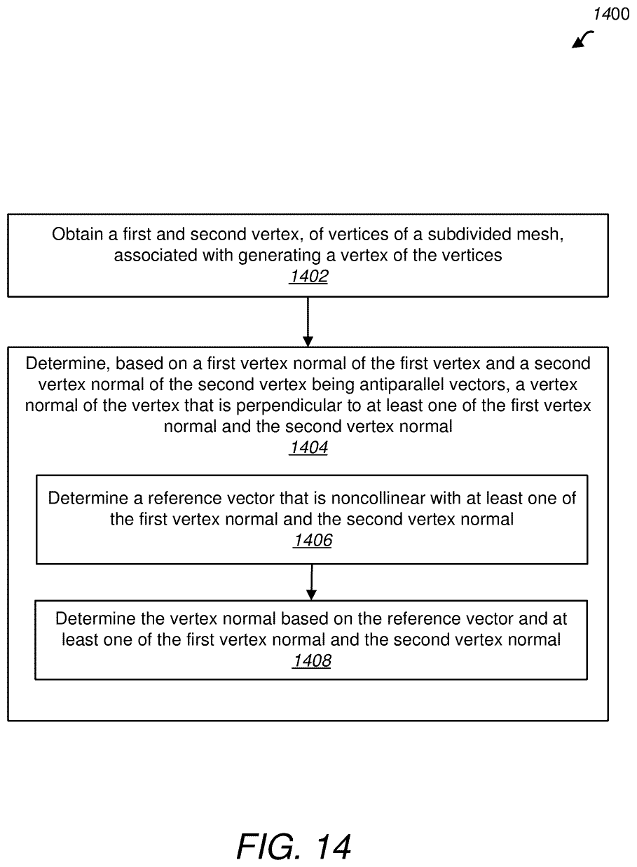

FIG. 14 illustrates a flowchart of a method 1400 for deriving non-zero vertex normals of vertices of a subdivided mesh, according to some embodiments. In some examples, method 1400 may be performed identically at an encoder and a decoder.

For example, method 1400 may be performed by an encoder such as encoder 114 of FIG. 1, encoder 200A of FIG. 2A, or encoder 200B of FIG. 2B. The following descriptions of various steps may refer to operations described above with respect to displacement generator 208 of FIG. 2A or FIG. 2B or mesh subdivider 418 or displacement generator 420 of FIG. 4.

For example, method 1400 may be performed by an decoder such as decoder 120 of FIG. 1, decoder 300 of FIG. 3. The following descriptions of various steps may refer to operations described above with respect to deformed mesh reconstructor 316 of FIG. 3.

At block 1402, a coder (e.g., encoder and/or decoder) obtains a first and second vertex, of vertices of a subdivided mesh for a 3D mesh, associated with generating a vertex of the vertices. For example, the subdivided mesh may be obtained by subdividing a base mesh associated with the 3D mesh.

In some examples, the first and second vertices may form an edge that was subdivided to generate the vertex in an iteration of subdividing the base mesh and corresponds to an LOD of LODs of the subdivided mesh.

At block 1404, the coder determines, based on a first vertex normal of the first vertex and a second vertex normal of the second vertex being antiparallel vectors (e.g., opposite vectors), a vertex normal of the vertex that is perpendicular to at least one of the first vertex normal and the second vertex normal. In some examples, the determined vertex normal is perpendicular to both the first and second vertex normals.

For example, the coder may determine whether a dot product of the first and second vertex normals indicate they are antiparallel vectors, as explained above with respect to FIG. 13.

For example, the coder may determine whether a sum or an average of the first and second vertex normals is zero, which indicates they may be antiparallel vectors, as explained above with respect to FIG. 13.

Block 1404 may include blocks 1406-1408 for generating the vertex normal that is non-zero and perpendicular to at least one of the first and second vertex normals.

At block 1406, the coder determines a reference vector that is noncollinear with at least one of the first vertex normal and the second vertex normal.

In some examples, the reference vector may be based on the first and second vertices, as explained with respect to FIG. 13.

In some examples, the reference vector may be set as one of the standard unit vectors, as explained with respect to FIG. 13.

In some embodiments, the encoder signals an indication of the reference vector in the bitstream and the decoder obtains the reference vector based on decoding the indication from the bitstream. For example, the indication may be signaled for a 3D mesh sequence, a 3D mesh frame in the sequence, a tile in the 3D mesh frame, a patch of the 3D mesh, a submesh of the 3D mesh, an LOD associated with the 3D mesh, etc.

In some examples, the indication indicates an index to a set of reference vectors. For example, the set of reference vectors may be the three standard unit vectors.

In some examples, the indication may include a value for each component of the reference vector (e.g., three scalar values for three components of the reference vector).

In some examples, the indication may indicate whether the reference vector is derived from the standard unit vectors or an edge formed by the first and second vertices.

At block 1408, the coder determines the vertex normal based on the reference vector and at least one of the first vertex normal and the second vertex normal, as explained with respect to FIG. 13.

In some examples, a reference vertex normal may be selected from or set to one of the first and second vertex normals. For example, the reference vertex normal may be set to the first vertex normal based on the first vertex having a lower vertex index than the second vertex associated with the second vertex normal. Accordingly, the vertex normal may be determined as a cross product between the reference vector and the reference vertex normal (e.g., a cross product of the reference vector and the reference vertex normal, or a cross product of the reference vertex normal and the reference vector).

In some examples, the encoder signals, in the bitstream, an indication of the order of the cross product, e.g., whether the cross product is of the reference vector and the reference vertex normal, or of the reference vertex normal and the reference vector. The decoder may obtain the indication from the bitstream to determine an order of the cross product.

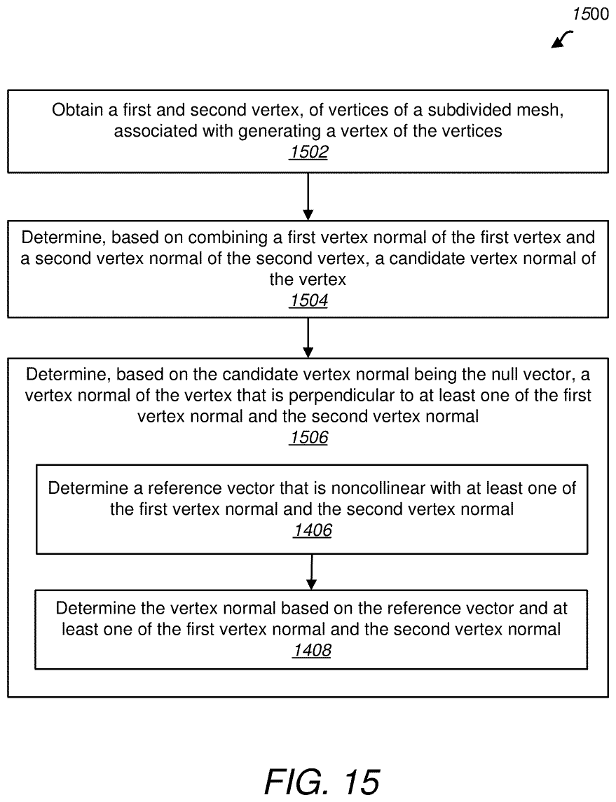

FIG. 15 illustrates a flowchart of a method 1500 for deriving non-zero vertex normals of vertices of a subdivided mesh, according to some embodiments. In some examples, method 1500 may be performed identically at an encoder and a decoder.

For example, method 1500 may be performed by an encoder such as encoder 114 of FIG. 1, encoder 200A of FIG. 2A, or encoder 200B of FIG. 2B. The following descriptions of various steps may refer to operations described above with respect to displacement generator 208 of FIG. 2A or FIG. 2B or mesh subdivider 418 or displacement generator 420 of FIG. 4.

For example, method 1500 may be performed by an decoder such as decoder 120 of FIG. 1, decoder 300 of FIG. 3. The following descriptions of various steps may refer to operations described above with respect to deformed mesh reconstructor 316 of FIG. 3.

At block 1502, a coder (e.g., encoder and/or decoder) obtains a first and second vertex, of vertices of a subdivided mesh for a 3D mesh, associated with generating a vertex of the vertices. For example, the subdivided mesh may be obtained by subdividing a base mesh associated with the 3D mesh. Block 1502 may correspond to block 1402 of FIG. 14.

At block 1504, the coder determines, based on combining a first vertex normal of the first vertex and a second vertex normal of the second vertex, a candidate vertex normal of the vertex.

In some examples, the candidate vertex normal may be determined based on an average of the first and second vertex normal, as explained above in FIG. 10.

In some examples, the candidate vertex normal may be determined based on a weighted average of the first and second vertex normal, as explained above in FIG. 11.

At block 1506, the coder determines, based on the candidate vertex normal being the null vector, a vertex normal of the vertex that is perpendicular to at least one of the first vertex normal and the second vertex normal. Block 1506 may include blocks 1406-1408 of FIG. 14 related to deriving the vertex normal based on a reference vector.

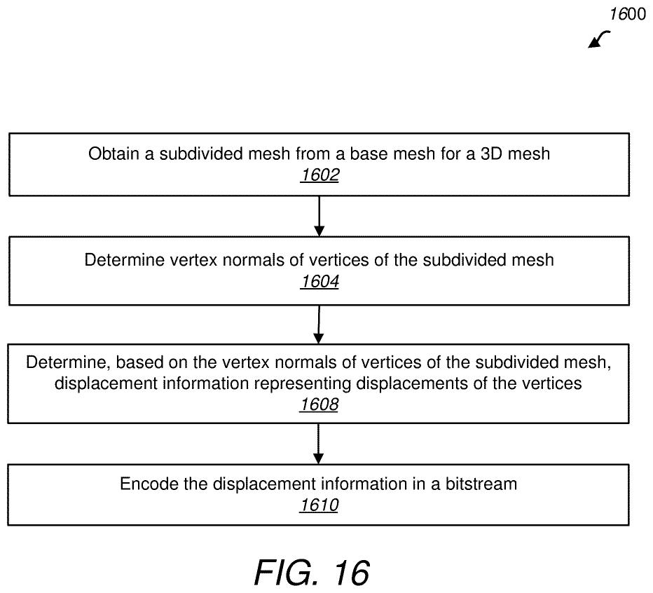

FIG. 16 illustrates a flowchart of a method 1600 for encoding displacements of vertices of a 3D mesh, according to some embodiments. In some examples, method 1600 may be performed by an encoder (e.g., encoder 114 of FIG. 1, encoder 200A of FIG. 2A, or encoder 200B of FIG. 2B). The following descriptions of various steps may refer to operations described above with respect to displacement generator 208 of FIG. 2A or FIG. 2B or mesh subdivider 418 or displacement generator 420 of FIG. 4.

At block 1602, the encoder obtains a subdivided mesh from a base mesh for the 3D mesh. For example, the encoder may obtain the base mesh based on decimating the 3D mesh, as explained above with respect to FIG. 4.

In some examples, the encoder signals/encodes the base mesh in a bitstream. For example, information indicating vertices, edges, and/or triangles of the base mesh may be signaled in the bitstream.

In some examples, the encoder subdivides the base mesh to generate a subdivided mesh. For example, the encoder may iteratively subdivide the base mesh by a number of iterations to generate the subdivided mesh. Vertices generated in each iteration of subdivision corresponds to a next LOD of LODs of the subdivided mesh.

In some examples, an iteration of subdividing the base mesh may be performed using a subdivision scheme from a plurality of subdivision schemes. For example, each iteration of subdivision may be associated with a corresponding subdivision scheme. In some examples, the encoder may signal, in a bitstream, a selected subdivision scheme for each respective iteration, which corresponds to a specific LOD.

At block 1604, the encoder determines vertex normals (e.g., unit vertex normals) of vertices of the subdivided mesh. In some examples, In some examples, a vertex normal of a vertex at an LOD is interpolated using vertex normals of vertices from lower LODs, as explained in FIGS. 10-11. Therefore, vertex normals of the vertices of the subdivided mesh may be derived per LOD by iteratively deriving vertex normals of vertices from lower LODs to higher LODs.

In some examples, vertex normals of vertices may be determined according to the normal interpolation processes described above with respect to FIGS. 10-11.

In some examples, vertex normals of vertices are further determined to be non-zero vectors according to the derivation process described above with respect to FIG. 14 or FIG. 15.

At block 1608, the encoder determines, based on the vertex normals of vertices of the subdivided mesh, displacement information representing displacements of the vertices. For example, a displacement at the vertex may be determined in reference to the vertex normal at the vertex, as explained above with respect to FIGS. 5A-B and 6. For example, the displacement may be determined as a displacement vector represented using a scalar value (e.g., with a magnitude and a sign) as the displacement information. For example, the displacement vector may be determined based on multiplying the vertex normal by the scalar value.

At block 1610, the encoder encodes the displacement information in a bitstream. For example, the encoder may transform the displacements information into wavelet coefficients by applying a lifting wavelet transform, as explained above in FIG. 8, and encoding the wavelet coefficients in images, as explained above in FIGS. 7A-B.

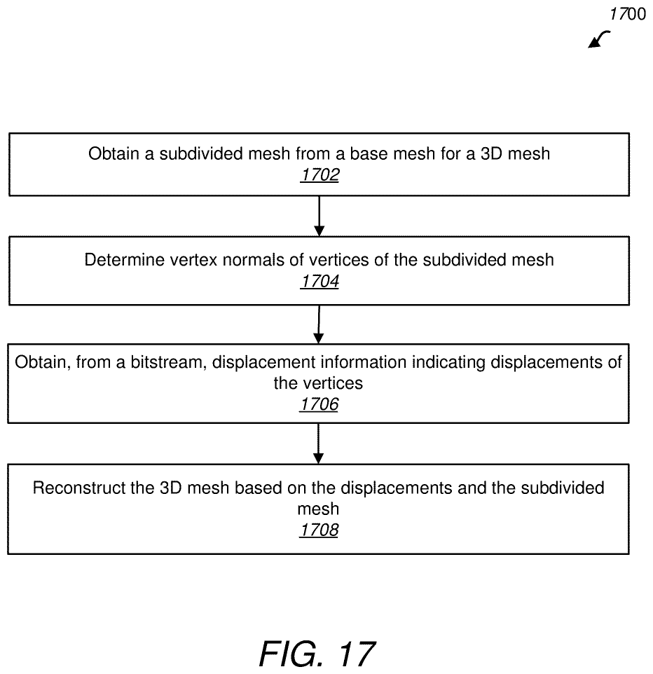

FIG. 17 illustrates a flowchart of a method 1700 for decoding displacements of vertices of a 3D mesh, according to some embodiments. In some examples, method 1700 may be performed by an decoder (e.g., decoder 120 of FIG. 1, decoder 300 of FIG. 3). The following descriptions of various steps may refer to operations described above with respect to deformed mesh reconstructor 316 of FIG. 3.

At block 1702, the decoder obtains a subdivided mesh from a base mesh for a 3D mesh. For example, the decoder may obtain the base mesh from the bitstream. The decoder subdivides the base mesh to generate a subdivided mesh. In some examples, the decoder identically subdivides the base mesh as the encoder and block 1702 may be the same as block 1602 of FIG. 16.

At block 1704, the decoder determines vertex normals of vertices of the subdivided mesh. In some examples, the decoder identically determines the vertex normals as the encoder and block 1704 correspond to block 1704 of FIG. 14.

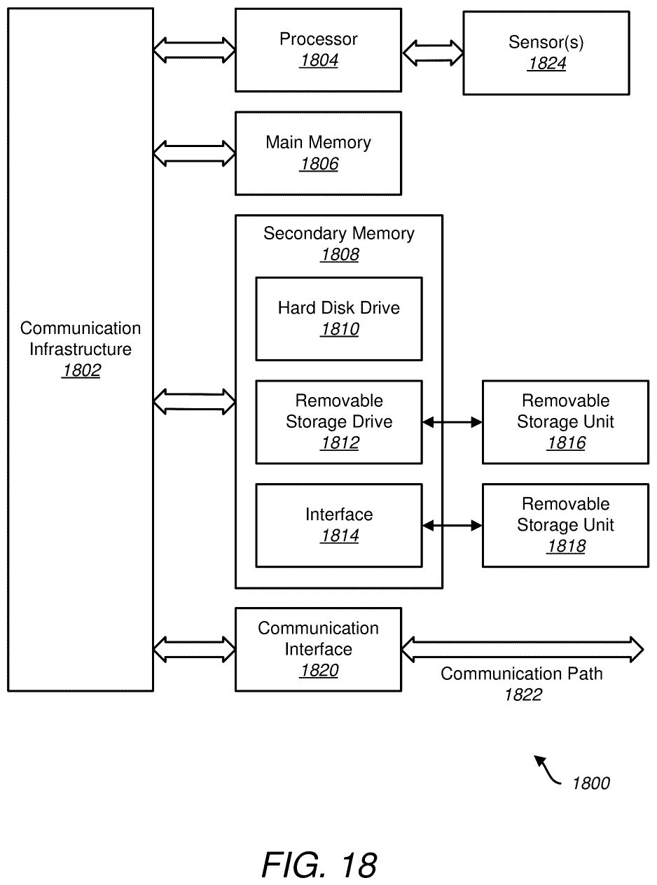

At block 1706, the decoder obtains, from the bitstream, displacement information (e.g., determined at block 1608 of FIG. 18) indicating displacements of the vertices.

In some examples, the decoder obtains, from the bitstream, transformed wavelet coefficients representing the displacements of the vertices. Then, the decoder may inverse transform the transformed wavelet coefficients to determine displacement information. For example, the displacement information may include components of displacement vectors. For example, the components (e.g., displacement normal component, displacement tangent component, displacement bitangent component) for a displacement vector of a vertex may correspond to the normal, tangent, and bitangent vectors of the vertex, as explained above with respect to FIG. 5B. In some examples, the displacement information may include a scalar value for one of the components corresponding to the normal vector of the vertex.

At block 1708, the decoder reconstructs the 3D mesh (e.g., the geometry of the 3D mesh) based on the displacements and the subdivided mesh. In some examples, the decoder reconstructs the displacements based on the displacement information and the vertex normals of the subdivided mesh.

For example, the decoder may derive a displacement vector representing a displacement at the vertex based on a product of the vertex normal at the vertex and the scalar value.

For example, the decoder may derive a displacement vector representing a displacement at the vertex based on a sum of products of: a displacement normal component with the normal vector, a displacement tangent component with the tangent vector, and a displacement bitangent component with the bitangent vector, as explained above in FIG. 5B.

In some examples, the decoder may combine (e.g., add) the displacements (e.g., displacement vectors) of respective vertices of the subdivided mesh with the respective vertices to reconstruct a geometry of the 3D mesh.

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 1800 is shown in FIG. 18. Blocks depicted in the figures above, such as the blocks in FIG. 1, may execute on one or more computer systems 1800. Furthermore, each of the steps of the flowcharts depicted in this disclosure may be implemented on one or more computer systems 1800. When more than one computer system 1800 is used to implement embodiments of the present disclosure, the computer systems 1800 may be interconnected by one or more networks to form a cluster of computer systems that may act as a single pool of seamless resources. The interconnected computer systems 1800 may form a “cloud” of computers.

Computer system 1800 includes one or more processors, such as processor 1804. Processor 1804 may be, for example, a special purpose processor, general purpose processor, microprocessor, or digital signal processor. Processor 1804 may be connected to a communication infrastructure 1802 (for example, a bus or network). Computer system 1800 may also include a main memory 1806, such as random access memory (RAM), and may also include a secondary memory 1808.

Secondary memory 1808 may include, for example, a hard disk drive 1810 and/or a removable storage drive 1812, representing a magnetic tape drive, an optical disk drive, or the like. Removable storage drive 1812 may read from and/or write to a removable storage unit 1816 in a well-known manner. Removable storage unit 1816 represents a magnetic tape, optical disk, or the like, which is read by and written to by removable storage drive 1812. As will be appreciated by persons skilled in the relevant art(s), removable storage unit 1816 includes a computer usable storage medium having stored therein computer software and/or data.

In alternative implementations, secondary memory 1808 may include other similar means for allowing computer programs or other instructions to be loaded into computer system 1800. Such means may include, for example, a removable storage unit 1818 and an interface 1814. Examples of such means may include a program cartridge and cartridge interface (such as that found in video game devices), a removable memory chip (such as an EPROM or PROM) and associated socket, a thumb drive and USB port, and other removable storage units 1818 and interfaces 1814 which allow software and data to be transferred from removable storage unit 1818 to computer system 1800.

Computer system 1800 may also include a communications interface 1820. Communications interface 1820 allows software and data to be transferred between computer system 1800 and external devices. Examples of communications interface 1820 may include a modem, a network interface (such as an Ethernet card), a communications port, etc. Software and data transferred via communications interface 1820 are in the form of signals which may be electronic, electromagnetic, optical, or other signals capable of being received by communications interface 1820. These signals are provided to communications interface 1820 via a communications path 1822. Communications path 1822 carries signals and may be implemented using wire or cable, fiber optics, a phone line, a cellular phone link, an RF link, and other communications channels.

Computer system 1800 may also include one or more sensor(s) 1824. Sensor(s) 1824 may measure or detect one or more physical quantities and convert the measured or detected physical quantities into an electrical signal in digital and/or analog form. For example, sensor(s) 1824 may include an eye tracking sensor to track the eye movement of a user. Based on the eye movement of a user, a display of a 3D mesh may be updated. In another example, sensor(s) 1824 may include a head tracking sensor to the track the head movement of a user. Based on the head movement of a user, a display of a 3D mesh may be updated. In yet another example, sensor(s) 1824 may include a camera sensor for taking photographs and/or a 3D scanning device, like a laser scanning, structured light scanning, and/or modulated light scanning device. 3D scanning devices may obtain geometry information by moving one or more laser heads, structured light, and/or modulated light cameras relative to the object or scene being scanned. The geometry information may be used to construct a 3D mesh.

As used herein, the terms “computer program medium” and “computer readable medium” are used to refer to tangible storage media, such as removable storage units 1816 and 1818 or a hard disk installed in hard disk drive 1810. These computer program products are means for providing software to computer system 1800. Computer programs (also called computer control logic) may be stored in main memory 1806 and/or secondary memory 1808. Computer programs may also be received via communications interface 1820. Such computer programs, when executed, enable the computer system 1800 to implement the present disclosure as discussed herein. In particular, the computer programs, when executed, enable processor 1804 to implement the processes of the present disclosure, such as any of the methods described herein. Accordingly, such computer programs represent controllers of the computer system 1800.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
generating a subdivided mesh from a base mesh for a 3D mesh;
generating vertex normals of vertices of the subdivided mesh, wherein a vertex normal of a vertex of the vertices is generated based on:
obtaining a first and second vertex, of the vertices, associated with generating the vertex; and
determining, based on a first vertex normal of the first vertex and a second vertex normal of the second vertex being antiparallel vectors, a vertex normal of the vertex that is perpendicular to the first vertex normal and the second vertex normal;
decoding, from a bitstream, displacement information associated with displacements of the vertices; and
reconstructing the displacements for the vertices based on the displacement information and the vertex normals.

2. The method of claim 1, wherein the first and second vertex normals are unit normal vectors.

3. The method of claim 1, wherein the first and second vertex normals are determined as being antiparallel vectors based on:
determining a combination of the first and second vertex normals to be a null vector; or
determining a dot product of the first and second vertex normals to be equal to negative one.

4. The method of claim 1, wherein the determining the vertex normal of the vertex comprises:
determining a reference vector as one of the standard unit vectors in 3D space; and
determining the vertex normal based on a cross product of the first vertex normal and the reference vector.

5. The method of claim 4, wherein the reference vector is determined to be one of the standard unit vectors that is not collinear with the first vertex normal and the second vertex normal.

6. The method of claim 1, wherein the determining the vertex normal of the vertex comprises:
determining a reference vector based on the first vertex and the second vertex; and
determining the vertex normal based on a cross product of the first vertex normal and the reference vector.

7. The method of claim 1, wherein the displacement information comprises scalar values, and wherein the displacements of the respective vertices are reconstructed based on products between the scalar values and respective vertex normals of the vertices.

8. A decoder comprising:
one or more processors; and
memory storing instructions that, when executed by the one or more processors, cause the decoder to:
generate a subdivided mesh from a base mesh for a 3D mesh;
generate vertex normals of vertices of the subdivided mesh, wherein a vertex normal of a vertex of the vertices is generated based on:
obtaining a first and second vertex, of the vertices, associated with generating the vertex; and
determining, based on a first vertex normal of the first vertex and a second vertex normal of the second vertex being antiparallel vectors, a vertex normal of the vertex that is perpendicular to the first vertex normal and the second vertex normal;
decode, from a bitstream, displacement information associated with displacements of the vertices; and
reconstruct the displacements for the vertices based on the displacement information and the vertex normals.

9. The decoder of claim 8, wherein the first and second vertex normals are unit normal vectors.

10. The decoder of claim 8, wherein the first and second vertex normals are determined as being antiparallel vectors based on:
determining a combination of the first and second vertex normals to be a null vector; or
determining a dot product of the first and second vertex normals to be equal to negative one.

11. The decoder of claim 8, wherein to determine the vertex normal of the vertex, the instructions further cause to decoder to:
determine a reference vector as one of the standard unit vectors in 3D space; and
determine the vertex normal based on a cross product of the first vertex normal and the reference vector.

12. The decoder of claim 11, wherein the reference vector is determined to be one of the standard unit vectors that is not collinear with the first vertex normal and the second vertex normal.

13. The decoder of claim 8, wherein to determine the vertex normal of the vertex, the instructions further cause to decoder to:
determine a reference vector based on the first vertex and the second vertex; and
determine the vertex normal based on a cross product of the first vertex normal and the reference vector.

14. The decoder of claim 8, wherein the displacement information comprises scalar values, and wherein the displacements of the respective vertices are reconstructed based on products between the scalar values and respective vertex normals of the vertices.

15. A non-transitory computer-readable medium comprising instructions that, when executed by one or more processors of a decoder, cause the decoder to:
generate a subdivided mesh from a base mesh for a 3D mesh;
generate vertex normals of vertices of the subdivided mesh, wherein a vertex normal of a vertex of the vertices is generated based on:
obtaining a first and second vertex, of the vertices, associated with generating the vertex; and
determining, based on a first vertex normal of the first vertex and a second vertex normal of the second vertex being antiparallel vectors, a vertex normal of the vertex that is perpendicular to the first vertex normal and the second vertex normal;
decode, from a bitstream, displacement information associated with displacements of the vertices; and
reconstruct the displacements for the vertices based on the displacement information and the vertex normals.

16. The non-transitory computer-readable medium of claim 15, wherein the first and second vertex normals are unit normal vectors.

17. The non-transitory computer-readable medium of claim 15, wherein the first and second vertex normals are determined as being antiparallel vectors based on:
determining a combination of the first and second vertex normals to be a null vector; or
determining a dot product of the first and second vertex normals to be equal to negative one.

18. The non-transitory computer-readable medium of claim 15, wherein to determine the vertex normal of the vertex, the instructions further cause to decoder to:
determine a reference vector as one of the standard unit vectors in 3D space that is not collinear with the first and second vertex normals; and
determine the vertex normal based on a cross product of the first vertex normal and the reference vector.

19. The non-transitory computer-readable medium of claim 15, wherein to determine the vertex normal of the vertex, the instructions further cause to decoder to:
determine a reference vector based on the first vertex and the second vertex; and
determine the vertex normal based on a cross product of the first vertex normal and the reference vector.

20. The non-transitory computer-readable medium of claim 15, wherein the displacement information comprises scalar values, and wherein the displacements of the respective vertices are reconstructed based on products between the scalar values and respective vertex normals of the vertices.
